(19) United States
(12) Patent Application Publication
(10) Pub. No.: US 2025/0011610 A1
(43) Pub. Date: Jan. 9, 2025

(54) INKJET INK AND METHOD FOR STORING INKJET INK

(71) Applicant: Konica Minolta, Inc., Tokyo (JP)

(72) Inventors: Ai KATSUDA, Tokyo (JP); Issei NAKAHARA, Tokyo (JP)

(21) Appl. No.: 18/751,702

(22) Filed: Jun. 24, 2024

(30) Foreign Application Priority Data
Jun. 30, 2023 (JP) 2023-107792

(51) Int. Cl. C09D 11/38

(52) U.S. Cl. CPC C09D 11/38

(57) ABSTRACT

An inkjet ink includes a polymerizable monomer, a blocked isocyanate, and a photopolymerization initiator. When the inkjet ink is stored at a temperature in a range of −15 to 40° C., and a humidity of 60% RH or less for one year from production thereof, a moisture content of the inkjet ink measured by a Karl Fischer method is in a range of 0.05 to 0.80 mass % with respect to a total mass of the inkjet ink.

### CROSS-REFERENCE TO RELATED APPLICATIONS

The entire disclosure of Japanese Patent Application No. 2023-107792 filed on Jun. 30, 2023, including description, claims, drawings and abstract is incorporated herein by reference.

### BACKGROUND OF THE INVENTION

### Technical Field

The present invention relates to an inkjet ink and a method for storing an inkjet ink. In particular, the present invention relates to, for example, an inkjet ink having a good ejection property and a stable curability even when the inkjet ink used contains a blocked isocyanate and is stored for a long period of time.

### Description of Related Art

Conventionally, photolithography and a screen printing method have been used for forming an etching resist, a solder resist, and markings for a printed wiring board.

As an application of the inkjet method to a method for producing a printed wiring board, for example, an inkjet ink containing a thermosetting agent is used for a copper-clad laminate for a printed wiring board. Furthermore, it has already been proposed to form a solder resist with an inkjet printer (see, for example, JP-B 06069300, Japanese Unexamined Patent Publication No. 2011-043565, and JP-B 05969208).

The inkjet method can greatly reduce the number of steps and time and effort as compared with photolithography which requires a photomask or a screen printing method of resist ink or marking ink which requires a screen plate. Furthermore, the inkjet method can also reduce consumables such as a developing solution, various inks, and a cleaning solvent. Furthermore, since the inkjet method can also reduce waste water, it can be expected to clean the environment.

However, in an ink containing the thermosetting agent, in particular, a blocked isocyanate, water or a hydroxy group contained in the ink reacts with the blocked isocyanate, thereby generating a solid matter. Therefore, there is a problem that curing or ejection failure easily occurs in the inkjet printer.

In particular, curable ink is usually heated to reduce the ink viscosity before ejection in order to increase the inkjet ejection performance, but heating further accelerates the generation of a solid matter.

Therefore, a method has been proposed in which the moisture content is suppressed to as low as 500 ppm during the production of an ink containing an isocyanate group (see, for example, Japanese Unexamined Patent Publication No. 2014-201593).

However, the method of suppressing the moisture content to 500 ppm generates a large production load, cause difficulty in maintenance/management and storage, and leads to an increase in cost. Further, the above method is based on the premise that the ink is used immediately after the production, and there is no mention of the moisture content after one year from the production.

### SUMMARY OF THE INVENTION

The present invention has been made in consideration of the above-mentioned problems and situations. The problem to be solved by the present invention is to suppress the generation of a solid matter in a coating film forming apparatus even when an inkjet ink containing a blocked isocyanate is used and stored for a long period of time. Accordingly, it is an object of the present invention to provide an inkjet ink and a method for storing the inkjet ink that exhibit satisfactory ejection properties and stable curability.

Note that hereinafter, the term “inkjet ink” may be simply referred to as “ink”.

In order to solve the above-mentioned problems, in the process of studying the causes of the above-mentioned problems, the present inventors have defined the moisture content of an inkjet ink containing a blocked isocyanate, the inkjet ink being one year after the production. As a result, the present inventors have found that it is possible to provide an inkjet ink or the like which can suppress generation of a solid matter in a coating film forming apparatus and can obtain good ejection properties and stable curability, and thus have reached the present invention.

To achieve at least one of the abovementioned objects, according to an aspect of the present invention, an inkjet ink reflecting one aspect of the present invention includes a polymerizable monomer, a blocked isocyanate, and a photopolymerization initiator,
wherein when the inkjet ink is stored at a temperature in a range of −15 to 40° C., and a humidity of 60% RH or less for one year from production thereof, a moisture content of the inkjet ink measured by a Karl Fischer method is in a range of 0.05 to 0.80 mass % with respect to a total mass of the inkjet ink.

According to an aspect of the present invention a method for storing the above inkjet ink reflecting one aspect of the present invention includes:
storing the inkjet ink at a temperature in a range of −15 to 40° C., and a humidity of 60% RH or less.

### DETAILED DESCRIPTION

Hereinafter, one or more embodiments of the present invention will be described with reference to the drawings. However, the scope of the invention is not limited to the disclosed embodiments.

An inkjet ink of the present invention is an inkjet ink containing a polymerizable monomer, a blocked isocyanate, and a photopolymerization initiator, wherein when the inkjet ink is stored at a temperature in the range of −15 to 40° C., and a humidity of 60% RH or less for one year from its production, the moisture content of the inkjet ink measured by the Karl Fischer method is in the range of 0.05 to 0.80 mass % with respect to the total mass.

This feature is a technical feature common to or corresponding to each of the following embodiments.

According to the above-described means of the present invention, it is possible to provide an inkjet ink and a method for storing the same, which can suppress generation of a solid matter in a coating film forming apparatus and can obtain good ejection properties and stable curability even when the ink is stored for a long period of time.

The expression mechanism or action mechanism of the effects of the present invention is not clear, but it is presumed as follows.

In the ink containing the blocked isocyanate, water or a hydroxy group contained in the ink reacts with the blocked isocyanate to generate a solid matter. In particular, heating such an ink accelerates the generation of the solid matter. As a result, in a case where a solid matter is generated in the coating film forming apparatus, it leads to poor ejection.

As an estimated mechanism of the generation of the solid matter, water or a hydroxy group contained in the ink reacts with the blocked isocyanate, the blocked isocyanate (NCO) moiety is hydrolyzed, and an amine is generated. Furthermore, an amino group and an NCO moiety react with each other to form a multimer in which a binding site becomes urea. Furthermore, it is presumed that an alcohol component generated by hydrolysis of the acrylic monomer reacts with the NCO moiety to form a polymer.

Therefore, in the present invention, the moisture content of the inkjet ink after storage at a temperature in the range of −15 to 40° C., and a humidity of 60% RH or less for one year after production is set within the above-described specific range. By reducing the moisture content over time in this manner, the generation of a solid matter in the coating film forming apparatus can be suppressed, the ejectability of the ink becomes satisfactory, and stable curability of the ink is obtained.

As an embodiment of the present invention, it is preferable to eject at 40° C. or more from the viewpoint of lowering the viscosity. That is, since a monomer having a large molecular weight or large interaction is used in order to exhibit the performance, the viscosity can be adjusted by heating to 40° C. or more and ejecting.

It is preferable that the blocked isocyanate has an aromatic ring structure from the viewpoint that both the thermal dissociation temperature and the curing performance can be achieved and the robustness against the generation of a solid matter during heating is enhanced.

The blocked isocyanate preferably has an isocyanurate structure from the viewpoint of excellent adhesion of a coating film.

It is preferable that a content of the polymerizable monomer having an octanol-water partition coefficient (C log P) value in the range of 2.0 to 7.0 in the inkjet ink is 30 mass % or more. Thus, the hygroscopicity can be reduced and the robustness of the generation of a solid matter can be extended.

The polymerizable monomer preferably includes at least one type of a polymerizable monomer having a bisphenol A structure because it is a hydrophobic monomer and has low hygroscopicity.

The sum of hydroxy values of compounds having a hydroxy group contained in the inkjet ink is preferably 60 mgKOH/g or less from the viewpoint that prevention of generation of a solid matter and ejection property are excellent.

A method for storing an inkjet ink of the present invention is characterized in that the inkjet ink is stored at a temperature of −15 to 40° C., and a humidity of 60% RH or less. Thus, an increase in the moisture content can be suppressed even when the ink is stored for a long period of time. As a result, the generation of a solid matter in the coating film forming apparatus is suppressed, and good ejection properties and stable curability are obtained.

Hereinafter, the present invention and constituent elements thereof, and modes and aspects for carrying out the present invention will be described. In the present description, when two figures are used to indicate a range of values before and after “to”, these figures are included in the range as a lower limit value and an upper limit value.

### 1. Outline of Inkjet Ink of Present Invention

The inkjet ink of the present invention is an inkjet ink containing a polymerizable monomer, a blocked isocyanate, and a photopolymerization initiator, wherein when the inkjet ink is stored at a temperature in the range of −15 to 40° C., and a humidity of 60% RH or less for one year from its production, the moisture content of the inkjet ink measured by the Karl Fischer method is in the range of 0.05 to 0.80 mass % with respect to the total mass.

In the present invention, the term “(meth) acrylate” means acrylate or methacrylate. The term “(meth) acryloyl group” means an acryloyl group or a methacryloyl group, and the term “(meth) acrylic” means acrylic or methacrylic.

The ink of the present invention functions as an insulating film (solder resist) by being applied to a substrate and then cured with active light in various fields such as metal processing, electronic circuits, printed circuit boards, plate making, the semiconductor field, and color filters. Furthermore, since the ink can be removed with an alkali after photocuring, the ink also functions as an etching resist used when an etching pattern is formed on a substrate.

Note that the ink can be used not only as the above-described ink for forming a solder resist pattern but also as an adhesive or sealant for electronic components, a circuit protecting agent, or the like.

In particular, the ink according to the present invention is preferably an ink for forming a solder resist pattern used for a printed wiring board. When a solder resist pattern (solder resist film) is formed using the ink according to the present invention, penetration of oxygen and moisture into the solder resist film can be prevented due to the high curability. In addition, the ink of the present invention provides good adhesion at the interface between a copper foil and a solder resist film in a printed wiring board, prevents migration of copper, and can suppress a decrease in insulating properties.

The ink of the present invention is an ink curable by active light.

The term “active light/rays” refers to rays that can impart energy to generate reaction initiating species, such as active radicals and ions, in an ink upon irradiation with the rays. The active rays include α-rays, γ-rays, X-rays, ultraviolet rays, electron beams, and the like. Among these, as the active rays, ultraviolet rays and electron beams are preferable, and ultraviolet rays are more preferable, from the viewpoints of curing sensitivity and availability of an apparatus. The active rays are also referred to as active energy rays.

### <Moisture Content>

The ink of the present invention is characterized in that when the ink is stored at a temperature in the range of −15 to 40° C., and a humidity of 60% RH or less for 1 year from the production, the moisture content of the ink measured by the Karl Fischer method is in the range of 0.05 to 0.80 mass % with respect to the total mass.

The moisture content of the ink is preferably within a range of 0.10 to 0.60% by mass.

Note that here, “when the ink is stored for 1 year from the production” refers to when it is stored for 1 year from the end of the production step of the ink.

The term “the end of the production step of the ink” refers to a point of time within 30 minutes immediately before the end of the ink preparation step.

In the present invention, the “moisture content of the ink when the ink is stored for one year after the production” refers to a moisture content of the ink stored for one year in an environment of a temperature in a range of −15 to 40° C., and a humidity of 60% RH or less.

### (Measurement Method of Moisture Content)

The moisture content according to the present invention can be measured by a known method such as the Karl Fischer method.

The method of measuring the moisture content by the Karl Fischer method is a method of quantifying the moisture content in a substance by utilizing the fact that a Karl Fischer reagent containing iodine, sulfur dioxide, and pyridine specifically reacts with water in the presence of methanol. In particular, the volumetric titration method is a method in which a titration solvent is placed in a titration flask, a sample is dissolved in the titration solvent to extract moisture in the sample, and then the sample is titrated with a Karl Fischer reagent containing iodine, sulfur dioxide, and a base as main components to determine the moisture content.

Water reacts with iodine and sulfur dioxide in the presence of a base and an alcohol.

H₂O+I₂+SO₂+CH₃OH+3RN→2RN·HI+RN·HSO₄CH₃

From the above formula, since H₂O and I₂ are 1:1 reaction, the number of milligrams of moisture (titer) per 1 ml of the Karl Fischer reagent is determined in advance with water or a water-standard material. Then, the moisture content (mg) is calculated from the titration amount (ml) of the Karl Fischer reagent required for the measurement of the sample.

Moisture Content (mg)=Karl Fischer Reagent Titration Amount (ml)×Titer (mgH₂O/ml)

The Karl Fischer reagent is also referred to as a KF reagent.

Then, the moisture content with respect to the total mass of the ink is calculated from the calculated moisture content.

$$Moisture Content ( \% ) = ( Amount of Water in Ink / Total Mass of Ink ) \times 100$$

Examples of means for setting the moisture content within the range of 0.05 to 0.80 mass % include controlling the octanol-water partition coefficient (C log P) value of the polymerizable monomer contained in the ink and controlling the hydroxy value in the ink. In addition, as other means for controlling the moisture content, heating the ink or the like may be mentioned.

The C log P value of the polymerizable monomer is preferably in the range of 2.0 to 7.0. Furthermore, it is preferable that 30 mass % or more of the polymerizable monomer having a C log P value in the range of 2.0 to 7.0 with respect to the total amount of the ink is contained, from the viewpoint of ejection stability.

The hydroxy value in the ink is preferably 60 mgKOH/g or less. In order that the hydroxy value in the ink falls within the above-described range, it is preferable to control the feed composition of a compound having a hydroxy value contained in the ink or purify the compound having a hydroxy value. Examples of the compound having a hydroxy value include (meth) acrylate and the like.

### 2. Configuration of Inkjet Ink

The ink of the present invention contains a polymerizable monomer, a blocked isocyanate, and a photopolymerization initiator. Hereinafter, the polymerizable monomer, the blocked isocyanate, the photopolymerization initiator, and the like will be described.

### <Polymerizable Monomer>

The polymerizable monomer according to the present invention is a monofunctional (meth) acrylate or a polyfunctional (meth) acrylate.

The monofunctional (meth) acrylate compound is a compound having one (meth) acrylate group in one molecule. Specific examples of the monofunctional (meth) acrylate compound include glycidyl (meth) acrylate, 3,4-epoxycyclohexyl (meth) acrylate, methylglycidyl (meth) acrylate, 3-methyl-3-(meth) acryloxymethyloxetane, 3-acryloxyethyloxetane, 3-ethyl-3-(meth) ethyl-3-(meth) acryloxymethyloxetane, 3-methyl-3-(meth) acryloxyethyloxetane, 2-phenyl-3-(meth) acryloxymethyloxetane, 2-trifluoromethyl-3-(meth) acryloxymethyloxetane, 4-trifluoromethyl-2-(meth) acryloxymethyloxetane, (meth) acrylic acid, methyl (meth) acrylate, ethyl (meth) acrylate, isopropyl (meth) acrylate, butyl (meth) acrylate, iso-butyl (meth) acrylate, t-butyl (meth) acrylate, cyclohexyl (meth) acrylate, benzyl (meth) acrylate, tricyclo [5.2.1.0^{2,6}]decanyl (meth) acrylate, dicyclopentenyloxyethyl (meth) acrylate, isobornyl (meth) acrylate, phenyl (meth) acrylate, glycerol mono (meth) acrylate, tetrahydrofurfuryl (meth) acrylate, (meth) acrylates of ethylene oxide adducts of lauryl alcohol, mono [2-(meth) acryloyloxyethyl] succinate, mono [2-(meth) acryloyloxyethyl] maleate, 2-hydroxyethyl (meth)acrylate, 2-hydroxypropyl (meth) acrylate, 4-hydroxybutyl (meth) acrylate, and 1,4-cyclohexanedimethanol mono (meth) acrylate, n-butyl (meth) acrylate, stearyl (meth) acrylate, lauryl (meth) acrylate, isodecyl (meth) acrylate, tridecyl (meth) acrylate and 2-(2-ethoxyethoxy) ethyl (meth) acrylate.

In the present invention, the “polyfunctional monomer” refers to a compound having two or more functional groups. Examples of the functional groups include an acryloyl group, a methacryloyl group, an allyl group, a vinyl group, and a vinyl ester group, each of which has an ethylenically unsaturated bond, from the viewpoint of curing by radical polymerization. Note that the functional groups are not limited to those described above.

Examples of a bifunctional acrylate include triethylene glycol diacrylate, tetraethylene glycol diacrylate, polyethylene glycol diacrylate, dipropylene glycol diacrylate (DPGDA), tripropylene glycol diacrylate, polypropylene glycol diacrylate, 1,4-butanediol diacrylate, 1,6-hexanediol diacrylate, 1,9-nonanediol diacrylate, neopentyl glycol diacrylate, propylene oxide (PO) adduct diacrylate of bisphenol A, hydroxypivalic acid neopentyl glycol diacrylate, polytetramethylene glycol diacrylate, tricyclodecanedimethanol dimethacrylate, tricyclodecanedimethanol diacrylate, and the like.

Examples of an acrylate having three or more functional groups include trimethylolpropane triacrylate, pentaerythritol triacrylate, pentaerythritol tetraacrylate, dipentaerythritol hexaacrylate, ditrimethylolpropane tetraacrylate, glycerolpropoxy triacrylate, and pentaerythritol ethoxy tetraacrylate.

Among the acrylates, phenoxyethyl acrylate, o-phenylphenol acrylate, and 2-hydroxy-3-phenoxypropyl acrylate are preferable from the viewpoint of suppressing curing shrinkage.

From the viewpoint of rapid curability, neopentyl glycol diacrylate, tricyclodecanedimethanol diacrylate, bisphenol A PO adduct diacrylate, and hydroxypivalic acid neopentyl glycol diacrylate are preferable.

The acrylate may be a modified product.

Examples of the acrylate which is a modified product include ethylene oxide-modified acrylates such as ethylene oxide-modified trimethylolpropane triacrylate and ethylene oxide-modified pentaerythritol tetraacrylate, propylene oxide-modified acrylates such as propylene oxide-modified trimethylolpropane triacrylate and propylene oxide-modified pentaerythritol tetraacrylate, caprolactone-modified acrylates such as caprolactone-modified trimethylolpropane triacrylate, and caprolactam-modified acrylates such as caprolactam-modified dipentaerythritol hexaacrylate.

### (Polyfunctional (Meth) Acrylate Having C Log P Value in Range of 2.0 to 7.0)

The ink according to the present invention preferably contains a polymerizable monomer having an octanol-water partition coefficient (C log P) value in the range of 2.0 to 7.0. That is, the ink of the present invention preferably contains a polyfunctional (meth) acrylate having a C log P value in the range of 2.0 to 7.0.

When the C log P value is in the range of 2.0 to 7.0, an amine derived from the blocked isocyanate hydrolyzed by moisture in the ink or a hydrolysate of the (meth) acrylate reacts with components in the ink to form a reaction product. In addition, since solubility of the formed reaction product is improved, it is possible to suppress a cured product or a foreign substance from being eluted as a solid, and ejection stability is improved.

Examples of the polyfunctional (meth) acrylate monomer having a C log P value in the range of 2.0 to 7.0 include EO-modified trimethylolpropane triacrylate (C log P 4.0), dipropylene glycol diacrylate (C log P 2.0), 1,10-decanediol dimethacrylate (C log P 5.75), tricyclodecanedimethanol diacrylate (C log P 4.69), and tricyclodecanedimethanol dimethacrylate (C log P 5.12).

As the polyfunctional (meth) acrylate according to the present invention, the following polyfunctional (meth) acrylates can also be used.

[Chem. 1]

| MONOMER | CLogP | STRUCTURE |
|---|---|---|
| A | 2.17 | 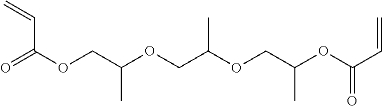 [SMILES: C=CC(=O)OCC(C)OCC(C)OCC(C)OC(=O)C=C] |
| B | 1.86 | 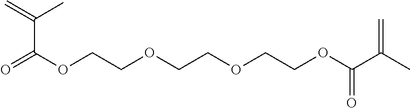 [SMILES: C=C(C)C(=O)OCCOCCOCCOC(=O)C(=C)C] |
| C | 1.52 | 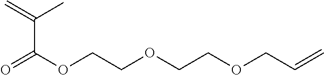 |
| D | 4.9 | 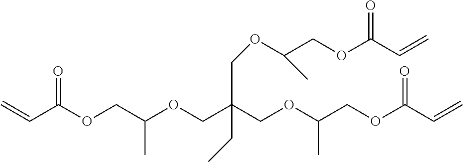 [SMILES: C=CC(=O)OCC(C)OCC(CC)(COC(C)COC(=O)C=C)COC(C)COC(=O)C=C] |
| E | 3.02 | 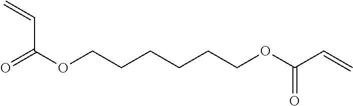 [SMILES: C=CC(=O)OCCCCCCOC(=O)C=C] |
| F | 6.81 | 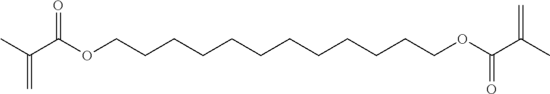 [SMILES: C=C(C)C(=O)OCCCCCCCCCCCCOC(=O)C(=C)C] |
| G | 7.34 | 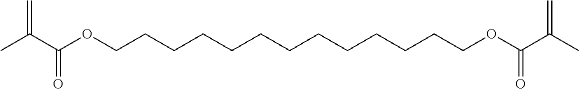 [SMILES: C=C(C)C(=O)OCCCCCCCCCCCCCOC(=O)C(=C)C] |

In addition, it is preferable that 30 mass % or more of a polyfunctional (meth) acrylate monomer having a C log P in a range of 2.0 to 7.0 with respect to the entire ink is contained, from the viewpoint of ejection stability. In particular, the ink of the present invention preferably contains 30 to 50 mass % of a polyfunctional (meth) acrylate monomer having a C log P value in the range of 2.0 to 7.0 relative to the entire ink.

In the present invention, the “C log P value” is a C log P value calculated by calculation.

The C log P The value can be calculated by a fragment method, an atomic approach method, or the like. More specifically, in order to calculate the C log P value, the fragment method described in the following document or the following commercially available software package 1 or 2 may be used.

Literature: C. Hansch and A. Leo, “Substituent Constants for Correlation Analysis in Chemistry and Biology” (John Wiley & Sons, New York, 1969).

Software Package 1: MedChem Software (Release 3.54, August 1991, Medicinal Chemistry Project, Pomona College, Claremont, CA).

Software Package 2: Chem Draw Ultra ver. 20.0.0.47 (PerkinElmer Informatics)

The numerical values of the C log P value described in the present specification/description or the like is the “C log P value” calculated using the software package 2.

### (Bisphenol A Structure)

The polyfunctional (meth) acrylate preferably includes at least one type of polyfunctional (meth) acrylate having a bisphenol A structure.

The polyfunctional (meth) acrylate monomer having a bisphenol A structure is preferably, for example, the above-described PO adduct diacrylate of bisphenol A, EO-modified bisphenol A diacrylate, or bisphenol A-type epoxy acrylate.

### (Hydroxy Value)

As described above, the sum of the hydroxy values of the compounds having a hydroxy group contained in the ink according to the present invention is preferably 60 mgKOH/g or less, and the lower limit is preferably 0.05 mgKOH/g from the viewpoint of adhesion. When the sum of the hydroxy values is within the above range, generation of a solid matter is suppressed even in a state where the ink contains water, and the storage stability is excellent.

Examples of means for setting the hydroxy values within the range of 0.05 to 60 mgKOH/g include appropriately selecting a compound having a hydroxy value to be contained in an ink, controlling the feed composition of a compound having a hydroxy value, and purifying a compound having a hydroxy value.

In the present invention, the term “hydroxy value” refers to the amount (mg) of potassium hydroxide (KOH) required to neutralize acetic acids bonded to hydroxy groups when 1 g of the ink of the present invention is acetylated.

The hydroxy value can be calculated according to the method described in JIS K0070-1992 or can be obtained by calculation from the feed composition of compounds having a hydroxy group in 1 g of the ink.

The hydroxy value in the present invention is determined from the feed composition of the compounds having a hydroxy group in 1 g of the ink, among the above-described calculation methods. A specific calculation method is as in the following formula (a).

$$Hydroxy value [ mgKOH / g ] = A [ mol ] \times \qquad ( a )$$

$$[ Number of Hydroxy Groups of Compounds having Hydroxy Group ] \times B [ mg / mol ]$$

In the above formula (a), “A” represents the number of moles of the compounds having a hydroxy group in 1 g of ink. Further, “B” represents the molecular weight of 1 mol of potassium hydrate (56000 [mg/mol]).

If two or more types of compound having a hydroxy group are contained in the ink, the hydroxy value is calculated for each compound having a hydroxy group by the formula (a). Then, the sum of the obtained hydroxyl values is defined as the hydroxyl value in 1 g of the ink.

The compound having a hydroxy group is not particularly limited as long as it is a compound having a hydroxy group in the structure thereof.

Examples of the hydroxyalkyl (meth) acrylate include 2-hydroxyethyl (meth)acrylate, 2-hydroxypropyl (meth) acrylate, and 4-hydroxybutyl (meth) acrylate.

Examples of the hydroxy (meth) acrylate having an alicyclic structure include 1,4-cyclohexanedimethanol mono (meth) acrylate.

Examples of the epoxy (meth) acrylate include aliphatic alcohol-based epoxy (meth) acrylate, aliphatic polyhydric alcohol-based epoxy (meth) acrylate, and phenol-based epoxy (meth) acrylate. Examples of the epoxy (meth) acrylate include a polyhydric phenol-based epoxy (meth) acrylate, an alicyclic carboxylic acid-based epoxy acrylate, and an aromatic carboxylic acid-based epoxy (meth) acrylate.

As the epoxy (meth) acrylate, a commercially available product can be used. Examples of the commercially available product include DENACOL ACRYLATE DA-111, DA-141, DA-212, DA-250, DA-314, DA-721, DA-722, DA-911M, DA-920, DA-931, and the like. These commercially available products are all manufactured by Nagase ChemteX Corporation.

These compounds having a hydroxy group may be used alone or in combination of two or more types thereof.

In the ink of the present invention, the content of the polymerizable monomer is preferably in the range of 40 to 90% by mass and more preferably in the range of 60 to 85% by mass relative to the total mass of the ink. When the content is within the above range, coating film adhesion is improved.

### <Blocked Isocyanate>

The blocked isocyanate is a compound in which an isocyanate group that the compound has is blocked with a blocking agent. Hereinafter, the compound having an isocyanate group may be referred to as an “isocyanate compound”.

The isocyanate group is activated by dissociation of the blocking agent from the blocked isocyanate by heating.

In the ink according to the present invention, the blocked isocyanate does not have reactivity until the ink is coated on a recording medium because its isocyanate group is blocked, and therefore the ink has storage stability. After coating, when the ink is heated at a temperature equal to or higher than the temperature at which the blocking agent dissociates, an isocyanate group is generated. Then, it reacts with a hydroxy group and/or a carboxy group of a monomer contained in the ink to form a coating film of the ink cured.

### (Isocyanate Compound)

It is preferable that the isocyanate compound is polyfunctional isocyanate from the viewpoint of curability.

The polyfunctional isocyanate is not particularly limited as long as it is a compound having two or more isocyanate groups in the molecule.

Specific examples of the polyfunctional isocyanate include: aromatic polyisocyanates such as 2,4-tolylene diisocyanate (2,4-TDI), 2,6-tolylene diisocyanate (2,6-TDI), 4,4′-diphenylmethane diisocyanate (4,4′-MDI), 2,4′-diphenylmethane diisocyanate (2,4′-MDI), 1,4-phenylene diisocyanate, xylylene diisocyanate (XDI), tetramethylxylylene diisocyanate (TMXDI), tolidine diisocyanate (TODI), and 1,5-naphthalene diisocyanate (NDI); aliphatic polyisocyanates such as hexamethylene diisocyanate (HDI), trimethylhexamethylene diisocyanate (TMHDI), lysine diisocyanate, and norbornane diisocyanate methyl (NBDI); cycloaliphatic polyisocyanates such as trans cyclohexane-1,4-diisocyanate, isophorone diisocyanate (IPDI), H6XDI (hydrogenated XDI), H12MDI (hydrogenated MDI), and H6TDI (hydrogenated TDI); polyisocyanates such as polymethylene polyphenylene polyisocyanate; and biuret products, isocyanurate products and carbodiimide-modified products of these; and the like.

In the ink of the present invention, any of these isocyanates may be used alone, or two or more types thereof may be used in combination.

### (Blocking Agent)

As the blocking agent, a known blocking agent can be used.

Examples of the blocking agent include alcohols such as ethanol, n-propanol, isopropanol, t-butanol, and isobutanol, phenols such as phenol, chlorophenol, cresol, xylenol, and p-nitrophenol, alkylphenols such as p-t-butylphenol, psec-butylphenol, p-sec-aminophenol, p-octylphenol, and p-nonylphenol, basic nitrogen-containing compounds such as 3-hydroxypyridine, 8-hydroxyquinoline, and 8-hydroxyquinaldine, active methylene compounds such as diethyl malonate, ethyl acetoacetate, and acetylacetone, acid amides such as acetamide, acrylamide, and acetanilide, acid imides such as succinimide and maleic acid imide, imidazoles such as 2-ethylimidazole and 2-ethyl-4-methylimidazole, pyrazoles such as pyrazole, 3-methylpyrazole, and 3,5-dimethylpyrazole, lactams such as 2-pyrrolidone and ε-caprolactam, oximes of ketones or aldehydes such as acetoxime, methyl ethyl ketone oxime, cyclohexanone oxime, butanone oxime, and acetaldoxime, ethyleneimine, bisulfite and the like.

The blocking agent is preferably at least one type of compound selected from the group consisting of oxime-based compounds, pyrazole-based compounds and active ethylene-based compounds, from the viewpoint of ink storability and thermal dissociation properties.

Examples of the oxime-based compound include formamide oxime, acetaldoxime, acetoxime, methyl ethyl ketone oxime, cyclohexanone oxime, and butanone oxime (MEKO).

Examples of the pyrazole-based compound include pyrazole, 3-methylpyrazole and 3,5-dimethylpyrazole.

Examples of the active ethylene-based compound include dimethyl malonate, diethyl malonate (DEM), methyl acetoacetate, ethyl acetoacetate, and acetylacetone.

Examples of the polyfunctional isocyanate compound having an isocyanate group protected by the blocking agent include 2-[(3,5-dimethylpyrazolyl) carbonylamino] ethyl methacrylate. Examples of the polyfunctional isocyanate compound having an isocyanate group protected by the blocking agent include 2-[(3-butylidene) aminooxycarbonylamino] ethyl methacrylate. Examples of the polyfunctional isocyanate compound having an isocyanate group protected by the blocking agent include 2-[(3,5-dimethylpyrazolyl) carbonylamino] ethyl acrylate. Examples of the polyfunctional isocyanate compound having an isocyanate group protected by the blocking agent include 2-[(3-butylidene) aminooxycarbonylamino] ethyl acrylate.

It is preferable that the blocked isocyanate has an aromatic ring structure from the viewpoints of ink storability and coating film performance.

The blocked isocyanate having an aromatic ring is not particularly limited, but examples thereof include aromatic polyisocyanates such as 2,4-tolylene diisocyanate (2,4-TDI), 2,6-tolylene diisocyanate (2,6-TDI), 4,4′-diphenylmethane diisocyanate 2,4′-diphenylmethane (4, 4′-MDI), diisocyanate (2, 4′-MDI), 1,4-phenylenediisocyanate, xylylene diisocyanate (XDI), tetramethylxylylene diisocyanate (TMXDI), tolidine diisocyanate (TODI), and 1,5-naphthalene diisocyanate (NDI).

Furthermore, as a blocking agent of the blocked isocyanate, an aromatic group may be contained, and a blocking agent containing a benzene ring and a blocking agent containing a heteroaromatic ring are preferable. In particular, dimethylpyrazole (DMP) is preferably contained as a blocking agent of the blocked isocyanate containing an aromatic group.

The blocked isocyanate may have the structure of polyisocyanate.

Examples of the structure of the polyisocyanate include three types of structures of an isocyanurate type, a biuret type, and an adduct type. As the blocked isocyanate of the present invention, an isocyanurate type and a biuret type are preferable from the viewpoint of curability and coating film performance, and an isocyanurate type (having an isocyanurate structure) is particularly preferable.

The content of the blocked isocyanate is preferably in a range of 0.1 to 20 parts by mass, and more preferably in a range of 1 to 10 parts by mass, relative to 100 parts by mass of the polymerizable monomer.

When the content of the blocked isocyanate is 0.1 parts by mass or more, curing by heat becomes sufficient. When the content of the blocked isocyanate is 20 parts by mass or less, the ink storability at high temperature is excellent.

As the blocking agent, one type may be used alone, two or more types may be used in combination, and a plurality of types of the blocked isocyanate blocked by one type or two or more types of the blocking agent may be used.

Commercially available products of the blocked isocyanate include, for example, BI7774, BI7779, BI7950, BI7960, BI7961, BI7981, BI7982, BI7991, BI7992 (all manufactured by LANXESS), MFK60X (manufactured by Asahi Kasei Chemicals Corporation), VPLS2253, BL4265SN (all manufactured by Sumika Bayer Urethane Co., Ltd), PU5211, PU5210 (both manufactured by Leeson Polyurethanes) Karenz MOI-BP (2-[(3, 5-dimethylpyrazolyl) carbonylamino]ethyl methacrylate), Karenz MOI-BM (2-(0-[1′-methylpropylideneamino] carboxyamino) ethyl methacrylate) (all manufactured by Showa Denko Corporation) and the like.

### <Photopolymerization Initiator>

When the polymerizable monomer (polyfunctional (meth) acrylate monomer) is a radically polymerizable compound, a photoradical initiator is preferably used as the photopolymerization initiator according to the present invention. When the polymerizable monomer is a cationically polymerizable compound, a photoacid generator is preferably used as the photopolymerization initiator according to the present invention.

The ink of the present invention may contain only one type of photopolymerization initiator or two or more types of photopolymerization initiator. The photopolymerization initiator may be a combination of a photoradical initiator and a photoacid generator.

The photoradical initiator includes a cleavage type radical initiator and a hydrogen abstraction type radical initiator.

Examples of the cleavage type radical initiator include acetophenone-based initiators, benzoin-based initiators, acylphosphine oxide-based initiators, and benzyl and methylphenyl glyoxyl esters.

Examples of the acetophenone-based initiator include diethoxyacetophenone, 2-hydroxy-2-methyl-1-phenylpropan-1-one, benzyldimethyl ketal, 1-(4-isopropylphenyl)-2-hydroxy-2-methylpropan-1-one, 4-(2-hydroxyethoxy) phenyl-(2-hydroxy-2-propyl) ketone, 1-hydroxycyclohexyl-phenylketone, 2-methyl-2-morpholino (4-thiomethylphenyl) propan-1-one and 2-benzyl-2-dimethylamino-1-(4-morpholinophenyl)-butanone.

Examples of the benzoin-based initiator include benzoin, benzoin methyl ether, and benzoin isopropyl ether.

Examples of the acylphosphine oxide-based initiator include 2,4,6-trimethylbenzoindiphenylphosphine oxides.

Examples of the hydrogen abstraction type radical initiator include a benzophenone-based initiator, a thioxanthone-based initiator, an aminobenzophenone-based initiator, and 10-butyl-2-chloroacridone. Examples of the hydrogen abstraction type radical initiator include 2-ethylanthraquinone, 9,10-phenanthrenequinone, and camphorquinone.

Examples of the benzophenone-based initiator include benzophenone, methyl o-benzoylbenzoate-4-phenylbenzophenone, 4,4′-dichlorobenzophenone, and hydroxybenzophenone. In addition, examples of the benzophenone-based initiator include 4-benzoyl-4′-methyl-diphenyl sulfide, acrylated benzophenone, 3, 3′, 4, 4′-tetra (t-butylperoxycarbonyl) benzophenone, and 3,3′-dimethyl-4-methoxybenzophenone.

Examples of the thioxanthone-based initiator include 2-isopropylthioxanthone, 2,4-dimethylthioxanthone, 2,4-diethylthioxanthone, and 2,4-dichlorothioxanthone.

Examples of the aminobenzophenone-based initiator include Michler's ketone and 4,4′-diethylaminobenzophenone.

Examples of the photoacid generator include compounds described in “Organic Materials for Imaging”, edited by The Society for the Study of Organic Electronics Materials, Bunshin Shuppan (1993), pages 187 to 192.

The content of the photopolymerization initiator may be in a range in which the ink can be sufficiently cured, and can be, for example, in a range of 0.01 to 10 mass % with respect to the total mass of the ink of the present invention.

Examples of commercially available products of the photopolymerization initiator include Omnirad TPO, Omnirad 379, and Omnirad TPO (all manufactured by Igm Resins B.V.). In addition, examples of commercially available products of the photopolymerization initiator include Speedgure ITX (manufactured by Sartomer Company, Inc) and Speedcure EPD (manufactured by Sartomer Company, Inc).

### <Polymerization Inhibitor>

It is preferable that the ink of the present invention further contains a polymerization inhibitor. By containing the polymerization inhibitor, the adhesiveness between a plurality of compounds having curability can be reduced.

The “polymerization inhibitor” includes all compounds which are added to inhibit a polymerization reaction during the preparation of an ink containing a polymerizable monomer or during storage after the preparation.

In the present invention, various conventionally known polymerization inhibitors can be used.

It is preferable to contain, as the polymerization inhibitor, any of an N-oxyl-based polymerization inhibitor, a phenol-based polymerization inhibitor containing an o-t-butyl group, and a polymerization inhibitor having two or more aromatic rings.

Among these, it is more preferable to contain an N-oxyl-based polymerization inhibitor from the viewpoint of adhesion to a printed wiring board.

In the ink of the present invention, the content of the polymerization inhibitor is preferably in the range of 0.05 to 0.5% by mass relative to the total mass of the ink.

### (N-Oxyl-Based Polymerization Inhibitor)

Examples of the N-oxyl-based polymerization inhibitor include, for example, 4-hydroxy-2,2,6,6-tetramethylpiperidine-N-oxyl (TEMPO), 4-hydroxy-2,2,6,6-tetramethyl-piperidine-N-oxyl, 4-oxo-2,2,6,6-tetramethyl-piperidine-N-oxyl, 4-methoxy-2,2,6,6-tetramethyl-piperidin-N-oxyl, 4-acetoxy-2,2,6,6-tetramethyl-piperidine-N-oxyl, Irgastab (registered trade name) UV10 (manufactured by Basf SE) and the like.

### (Phenol-Based Polymerization Inhibitor)

Examples of the phenol-based polymerization inhibitor include 2,6-di-tert-butylphenol, 2,4-di-tert-butylphenol, and 2-tert-butyl 4,6-dimethylphenol. In addition, examples of the phenol-based polymerization inhibitor include 2,6-di-tert-butyl-4-methylphenol and 2,4,6-tri-tert-butylphenol. In addition, examples of the phenol-based polymerization inhibitor include 2,6-di-t-butyl-p-cresol (butylated hydroxytoluene: BHT), 4-methoxyphenol, and 2-methoxy-4-methylphenol.

### (Quinone-Based Polymerization Inhibitor)

Examples of the quinone-based polymerization inhibitor include hydrochinone, methoxyhydroquinone, benzoquinone, 1,4-naphthoquinone, p-tert-butylcatechol and the like.

### (Amine-Based Polymerization Inhibitor)

Examples of the amine-based polymerization inhibitor include alkylated diphenylamine, N,N′-diphenyl-p-phenylenediamine, and phenothiazine.

### (Other Polymerization Inhibitors)

Examples of other polymerization inhibitors include copper dithiocarbamate-based polymerization inhibitors such as copper dimethyldithiocarbamate, copper diethyldithiocarbamate, and copper dibutyldithiocarbamate.

Only one of these may be contained, or two or more of these may be contained.

Among these, N-oxyl-based and quinone-based polymerization inhibitors are preferable. As the inhibitor, 4-hydroxy-2,2,6,6-tetramethylpiperidine-N-oxyl (TEMPO) is preferable. As the inhibitor, 2,6-di-t-butyl-p-cresol (butylated hydroxytoluene: BHT) and 2,4-di-tert-butylphenol are preferable. As the polymerization inhibitor having two or more aromatic rings, naphthoquinone and the like are preferable.

### <Other Components>

### (Surfactant)

The ink of the present invention may further contain a surfactant, if necessary.

Examples of the surfactant include an anionic surfactant, a nonionic surfactant, a cationic surfactant, and a silicone-based or fluorine-based surfactant.

Examples of the anionic surfactant include dialkylsulfosuccinates, alkylnaphthalenesulfonates, and fatty acid salts.

Examples of the nonionic surfactant include polyoxyethylene alkyl ethers, polyoxyethylene alkyl allyl ethers, acetylene glycols, and polyoxyethylene-polyoxypropylene block copolymers.

Examples of the cationic surfactant include alkylamine salts and quaternary ammonium salts.

### (Colorant)

The ink of the present invention may further contain a colorant, if necessary.

The colorant may be a pigment or a dye, but is preferably a pigment from the viewpoint of having good dispersibility in constituent components of the ink and excellent weather resistance.

The pigment is not particularly limited, and examples thereof include organic pigments or inorganic pigments having the following numbers listed in the Color Index.

The ink of the present invention may contain only one type of colorant, may contain two or more types of colorant, or may be adjusted to a desired color.

The content of the colorant is preferably in a range of 0.1 to 20% by mass and more preferably in a range of 0.2 to 10% by mass with respect to the total mass of the ink.

### (Pigment)

### <<Red or Magenta Pigment>>

Examples of red or magenta pigments include Pigment Red 3, 5, 19, 22, 31, 38, 43, 48:1, 48:2, 48:3, 48:4, 48:5, 49:1, 53:1, 57:1, 57:2, 58:4, 63:1, 81, 81:1, 81:2, 81:3, 81:4, 88, 104, 108, 112, 122, 123, 144, 146, 149, 166, 168, 169, 170, 177, 178, 179, 184, 185, 208, 216, 226, 257, Pigment Violet 3, 19, 23, 29, 30, 37, 50, 88, Pigment Orange 13, 16, 20, 36 and mixtures of any selected from these.

### <<Blue or Cyan Pigment>>

Examples of blue or cyan pigments include Pigment Blue 1, 15, 15:1, 15:2, 15:3, 15:4, 15:6, 16, 17:1, 22, 27, 28, 29, 36, 60 and mixtures of any selected from these.

### <<Green Pigment>>

Examples of green pigments include Pigment Green 7, 26, 36, and 50, and mixtures of any selected from these.

### <<Yellow Pigment>>

Examples of yellow pigments include Pigment Yellow 1, 3, 12, 13, 14, 17, 34, 35, 37, 55, 74, 81, 83, 93, 94, 95, 97, 108, 109, 110, 137, 138, 139, 147, 153, 154, 155, 157, 166, 167, 168, 180, 185, 193 and mixtures of any selected from these.

### <<Black Pigment>>

Examples of black pigments include Pigment Black 7, 28, and 26, and mixtures of any selected from these.

### <<Examples of Commercially Available Pigment>>

Examples of commercially available pigments include Black Pigment (manufactured by Mikuni); Chromofine Yellow 2080, 5900, 5930, AF-1300, 2700L, Chromofine Orange 3700L, 6730, Chromofine Scarlet 6750, Chromofine Magenta 6880, 6886, 6891N, 6790, 6887, Chromofine Violet RE, Chromofine Red 6820, 6830, Chromofine Blue HS-3, 5187, 5108, 5197, 5085N, SR-5020, 5026, 5050, 4920, 4927, 4937, 4824, 4933GN-EP, 4940, 4973, 5205, 5208, 5214, 5221, 5000P, Chromofine Green 2GN, 2GO, 2G-550D, 5310, 5370, 6830, Chromofine Black A-1103, Seikafast Yellow 10GH, A-3, 2035, 2054, 2200, 2270, 2300, 2400 (B), 2500, 2600, ZAY-260, 2700 (B), 2770, Seikafast Red 8040, C405 (F), CA120, LR-116, 1531B, 8060R, 1547, ZAW-262, 1537B, GY, 4R-4016, 3820, 3891, ZA-215, Seikafast Carmine 6B1476T-7, 1483LT, 3840, 3870, Seikafast Bordeaux 10B-430, Saika Light Rose R40, Seika Light Violet B800, 7805, Seikafast Maroon 460N, Seikafast Orange 900, 2900, Seika Light Blue C718, A612, Cyanine Blue 4933M, 4933GN-EP, 4940, 4973 (manufactured by Dainichiseika Color & Chemicals Mfg. Co., Ltd, note “Chromofine” is a registered trademark owned by the company); KET Yellow 401, 402, 403, 404, 405, 406, 416, 424, KET Orange 501, KET Red 301, 302, 303, 304, 305, 306, 307, 308, 309, 310, 336, 337, 338, 346, KET Blue 101, 102, 103, 104, 105, 106, 111, 118, 124, KET Green 201 (manufactured by DIC Corporation); Colortex Yellow 301, 314, 315, 316, P-624, 314, U10GN, U3GN, UNN, UA-414, U263, Finecol Yellow T-13, T-05, Pigment Yellow 1705, Colortex Orange 202, Colortex Red 101, 103, 115, 116, D3B, P-625, 102, H-1024, 105C, UFN, UCN, UBN, U3BN, URN, UGN, UG276, U456, U457, 105C, USN, Colortex Maroon 601, Colortex Brown B610 N, Colortex Violet 600, Pigment Red 122, Colortex Blue 516, 517, 518, 519, A818, P-908, 510, Colortex Green 402, 403, Colortex Black 702, U905 (manufactured by Sanyo Shikiso Co, note “Colortex” and “Finecol” are registered trademarks of the company); Lionol Yellow 1405G, Lionol Blue FG7330, FG7350, FG7400G, FG7405G, ES, ESP-S (manufactured by Toyo Ink Co., Ltd, note “Lionol” is a registered trademark of the company); Toner Magenta E02, Permanent Rubin F6B, Toner Yellow HG, Permanent Yellow GG-02, Hostapeam Blue B2G (manufactured by Hoechst Industries, Ltd); Novoperm P-HG, Hostaperm Pink E, Hostaperm Blue B2G (manufactured by Clariant, note “Novoperm” and “Hostaperm” are registered trademarks of the company); carbon black #2600, #2400, #2350, #2200, #1000, #990, #980, #970, #960, #950, #850, MCF88, #750, #650, MA600, MA7, MA8, MA11, MA100, MA100R, MA77, #52, #50, #47, #45, #45L, #40, #33, #32, #30, #25, #20, #10, #5, #44, CF9 (manufactured by Mitsubishi Chemical Corporation); and the like.

### <<Dispersion of Pigment>>

The pigment can be dispersed using, for example, a ball mill, a sand mill, an attritor, a roll mill, an agitator, a Henschel mixer, a colloid mill, an ultrasonic homogenizer, a pearl mill, a wet-type jet mill, or a paint shaker.

The dispersion of the pigment is preferably performed such that the volume average particle diameter of the pigment particles is in a range of 0.08 to 0.5 μm. Furthermore, the pigment is dispersed such that the maximum particle diameter of the pigment particles is preferably in a range of 0.3 to 10 μm and more preferably in a range of 0.3 to 3 μm.

The dispersion of the pigment is adjusted by selection of the pigment, the dispersant, and the dispersion medium, dispersion conditions, filtration conditions, and the like.

### <<Dispersant>>

The ink according to the present invention may further contain a dispersant in order to enhance the dispersibility of the pigment.

Examples of the dispersant include carboxylic acid ester having a hydroxy group, salt of long-chain polyaminoamide and high-molecular-weight acid ester, salts of high molecular weight polycarboxylic acids, salt of long-chain polyaminoamide and polar acid ester, high molecular weight unsaturated acid ester, high molecular copolymer, modified polyurethane, modified polyacrylate, polyetherester-type anionic activator, naphthalenesulfonic acid formalin condensate salt, aromatic sulfonic acid formalin condensate salt, polyoxyethylene alkyl phosphate ester, polyoxyethylene nonylphenyl ether, and stearylamine acetate and the like. Examples of commercially available products of the dispersant include Solsperse® series manufactured by Avecia Inc, and PB series manufactured by Ajinomoto Fine-Techno Co., Inc.

### <<Dispersion Aid>>

The ink according to the present invention may further contain a dispersion aid, if necessary.

The dispersion aid may be selected according to the pigment.

The total content of the dispersant and the dispersion aid is preferably in the range of 1 to 50 mass % relative to the total mass of the pigment.

### <<Dispersion Medium>>

The ink according to the present invention may further contain a dispersion medium for dispersing the pigment, if necessary.

Although the ink according to the present invention may contain a solvent as a dispersion medium, the above-described monomer is preferably used as the dispersion medium in order to prevent the solvent from remaining in the formed image. Examples of the above-described monomer include monomers having particularly low viscosity.

In addition, when a solvent is used as the dispersion medium, in a case where the ink is heated from the viewpoint of ejection stability, the solvent is easily volatilized, and the dispersibility of the pigment is easily deteriorated. However, by using the above-described polyfunctional (meth) acrylate monomer, a decrease in the dispersibility of the pigment can be suppressed.

### (Other Additives)

The ink of the present invention may further contain a coupling agent, a solvent, and the like, if necessary.

### <<Coupling Agent>>

The ink according to the present invention may further contain various coupling agents, if necessary. The inclusion of the coupling agent can improve adhesion to a printed wiring board.

Examples of the various coupling agents include silane-based, titanium-based, and aluminum-based coupling agents.

### <<Curing Accelerator>>

In the present invention, a curing accelerator may be contained, if necessary.

Any curing accelerator can be used without particular limitation as long as it accelerates the thermal curing of the resin component.

Examples of the curing accelerator include imidazoles, dicyandiamide derivatives, dicarboxylic acid dihydrazide, triphenylphosphine, and tetraphenylphosphonium tetraphenylborate. In addition, examples of the curing accelerator include 2-ethyl-4-methyl imidazole-tetraphenyl borate and 1,8-diazabicyclo [5.4.0] undecene-7-tetraphenyl borate.

### <<Ion Scavenger>>

In the present invention, an ion scavenger may be included as necessary.

When the ion scavenger is included, there are advantages that ionic impurities are adsorbed, and the insulating properties under the conditions in which the cured film has absorbed moisture are improved, and the like.

Examples of the ion scavenger include inorganic ion adsorbents such as a triazine thiol compound, a bisphenol-based reducing agent, a zirconium compound, and an antimony bismuth-based magnesium aluminum compound.

### <<Flame Retardant>>

In the present invention, a flame retardant may be contained as required.

As the flame retardant, hydrated metal-based flame retardants such as aluminum hydroxide and magnesium hydroxide, red phosphorus, ammonium phosphate, ammonium carbonate, zinc borate, zinc stannate, molybdenum compound-based flame retardants, bromine compound-based flame retardants, and chlorine compound-based flame retardants can be used. In addition, as the flame retardant, a phosphate ester, a phosphorus-containing polyol, a phosphorus-containing amine, melamine cyanurate, a melamine compound, a triazine compound, a guanidine compound, a silicon polymer and the like can be used.

### <<Solvent>>

The ink of the present invention is preferably solvent-free from the viewpoints of rapid curability and ejection stability, but a solvent may be added for adjustment of the ink viscosity.

### 3. Method for Producing Inkjet Ink

The ink of the present invention can be prepared by mixing the above-described polymerizable monomer, blocked isocyanate, photopolymerization initiator, and other components. It is preferable to clear the obtained mixed liquid by a predetermined filter. Note that in a case of preparing an ink containing a pigment, it is preferable to prepare a pigment dispersion liquid containing the pigment and a polymerizable monomer and then mix the pigment dispersion liquid with other components. The pigment dispersion liquid may further contain a dispersant.

The pigment dispersion liquid can be prepared by dispersing a pigment in a polymerizable compound.

The pigment can be dispersed using, for example, a ball mill, a sand mill, an attritor, a roll mill, an agitator, a Henschel mixer, a colloid mill, an ultrasonic homogenizer, a pearl mill, a wet-type jet mill, a paint shaker, or the like. At this time, a dispersant may be added.

### 4. Method for Storing Inkjet Ink

The method for storing an ink according to the present invention is a method for storing the above-described ink according to the present invention, wherein the ink is stored at a temperature in the range of −15 to 40° C., and a humidity of 60% RH or less.

Specifically, for storage of the ink within the aforementioned temperature and humidity ranges, the following ink container is preferably used as the container housing the ink of the present invention.

### [Ink Container]

The ink according to the present invention is preferably stored in an ink container having a water vapor transmission rate in a range of 0.05 to 1.50 g/m² day/atm under the conditions of 40° C., and 90% RH. Hereinafter, the ink container is also simply referred to as a “container”.

The container is a member that is filled with ink and substantially holds the ink.

Embodiments of the container in the present invention include, but are not limited to, an ink cartridge, a pack, a bottle, a tank, a bin, and a can, for example. Among these, an ink cartridge, a pack, a bottle, and a tank are preferable, and a pack is more preferable, because they are generally used, and the water vapor transmittance rate can be easily controlled to a desired value. In addition, the ink of the present invention may be contained in a bottle and then further contained in a pack.

The pack is a container using a flexible film. The pack is preferable in that the pack is light in weight and is easily put in a box-shaped container, the volume thereof easily changes according to the remaining amount of the ink, and the film can be processed into a bag shape by thermal fusion (heat sealing) for use.

Note that modes of use of the container of the present embodiment include at least the following forms (A) to (C).
(A) Form such as an ink cartridge which is separate from an inkjet recording apparatus (coating film apparatus) and is mounted on the recording apparatus to sequentially supply the composition to the recording apparatus
(B) Form separate from the recording apparatus and moving the ink only from the container to the recording apparatus when the ink is used
(C) Form such as a tank which is provided in the recording apparatus in advance and in which ink is accommodated

The above-described (A) and (B) can be referred to as an ink container from shipment of the container to immediately before supply (transfer) of ink to a recording apparatus.

The above-described (C) can be referred to as an ink container from shipment of a recording apparatus until the start of the first use of ink in the recording apparatus.

The above-described (A) and (C) can be referred to as an ink container of ink with which a recording apparatus performs printing in a state where the ink is supplied from the container to the recording apparatus via a connection portion such as an ink tube.

The above-described (B) can be referred to as an ink container of ink with which a recording apparatus performs printing after the ink is moved from the container to the recording apparatus. Examples of an object to which the ink is moved in the (B) include a tank provided in a recording apparatus.

Examples of the constituent material of the container include polyethylene terephthalate (PET), polypropylene (PP), polyethylene, ethylene-vinyl acetate copolymer, ethylene-vinyl alcohol copolymer (EVOH), and polystyrene. The container may be made of a film of any of these materials.

Further, the container may be formed by mixing the above materials at an appropriate ratio or by stacking two or more of the above materials. In the case of a film, the container may be obtained by lamination. When a plurality of types of films are laminated, it is unnecessary that all the plurality of types of films are the above-mentioned films, and a part of the films may be films composed of other materials, for example, a metal and a metal compound.

Furthermore, from the viewpoint of increasing the flexibility of the container, a plasticizer may be contained as a constituent material of the container.

Examples of the plasticizer include fatty acid esters, epoxy compounds, and polyester compounds. Among these, fatty acid esters are preferable from the viewpoint of versatility as a plasticizer. Examples of the fatty acid ester include a phthalate ester, an adipate ester, a trimellitate ester, and a citrate ester. These fatty acid esters may be used alone or in combination of two or more.

The container may be stirred during storage and transportation in order to release sedimentation of components contained in the ink stored therein. This is because, if a long period of time elapses after sedimentation of components contained in the ink, the sediment may cake, making it difficult to release the sedimentation. When the ink is supplied from the container to the recording apparatus, it is preferable to release the sedimentation by stirring the accommodation body.

In a case where the container is a container (pack) using a flexible film, durability is required so that a crack or a tear does not occur, in particular, with stirring operation.

Preferred examples of the film material having good durability include plastic films of polyethylene terephthalate (PET), polypropylene, polyethylene, ethylene-vinyl acetate copolymer, ethylene-vinyl alcohol copolymer, and polystyrene. The film material is more preferably an ethylene-vinyl acetate copolymer.

Preferred examples of the film include stretched plastic films of high-density, low-density, or linear low-density polyethylene, polypropylene, ethylene-vinyl alcohol copolymer, polystyrene, and the like. A laminated film in which a plurality of films is bonded may be used.

In a case where the container is the above-described pack, when a component contained in the ink settles, the pack may be shaken from side to side to stir the ink and cause the ink to recover from settling. In that case, a plasticizer can be contained as a constituent material of the pack from the viewpoint of preventing the pack from being cracked or broken. The plasticizer may be any of those described above, and is preferably a fatty acid ester.

When the container is the pack described above, the water vapor transmission rate of the film forming the pack is preferably within a range of 0.05 to 1.50 g/m²·day/atm under the conditions of 40° C., and 90% RH. The water vapor transmission rate is more preferably within a range of 0.05 to 1.00 g/m²·day·atm, and particularly preferably within a range of 0.05 to 0.5 g/m²·day·atm.

Use of the film having a water vapor transmission rate within the range of 0.05 to 1.50 g/m²·day·atm can reduce an increase in the amount of moisture in the ink filled in the pack even when the pack is stored for a long period of time.

In order to adjust the water vapor transmission rate to 1.50 g/m²·day·atm or less, for example, a material constituting the film may be selected, or a layer composed of at least one of a metal and a metallic compound may be provided on the film.

Of these, from the viewpoint of high versatility, it is preferable to provide a layer formed of at least one of a metal and a metal compound.

Examples of the metal include Al and Ti. The metal compound is preferably a metal oxide, and examples thereof include alumina, silica, titania, and zirconia. These are used singly or in combination of two or more types thereof. Note that in the present specification/description, the metal oxide includes silica.

The thickness of the film forming the pack is preferably within a range of 50 to 200 μm. The lower limit of the thickness of the film is preferably 70 μm or more, more preferably 80 μm or more. The upper limit of the thickness of the film is preferably 150 μm or less, more preferably 130 μm or less. The thickness of the film is the total thickness when the film is a laminated film consisting of a plurality of layers. The thickness of the film being within the above range is preferable in terms of durability and flexibility of the film.

The volume of ink that the container can store is not limited to the following, but is preferably in a range of 100 to 5000 mL. The lower limit of the volume of the ink is preferably 200 mL or more, and more preferably 500 mL or more. The upper limit of the volume of the ink is preferably 3000 mL or less, more preferably 2000 mL or less, and still more preferably 1000 mL or less. When the volume is within the above range, all of the curability, the storage stability, and the ejection stability can be more excellent.

### 5. Solder Resist and Printed Wiring Board

For a solder resist, the above-described ink of the present invention is preferably used.

As a method for forming a solder resist pattern, first, patterning is performed by inkjet printing on an oxide film having conductivity, such as copper or zinc, formed on a substrate with the ink according to the present invention.

Next, the ink is cured by light to form a resist film.

Then, a portion of the oxide film which is not covered with the resist film is removed by an etching solution using an acid.

Further, the resist film covering the oxide film is removed with an alkali, so that a fine circuit or pattern can be formed.

In this way, a printed wiring board having a solder resist is formed.

### 6. Method for Forming Coating Film

The method for forming a coating film using the ink of the present invention preferably includes the following steps (1) to (5).
(1) Step of heating ink
(2) Step of deaerating the ink
(3) Step of ejecting the heated ink from a nozzle of an inkjet head to land the ink on a circuit-formed printed wiring board
(4) Step of irradiating the landed ink with active rays to temporarily cure the ink
(5) Step of heating the ink to fully cure the ink after the temporary curing

Hereinafter, a method for forming a resist film will be described as an example of the method for forming a coating film.

### <Step (1)>

Step (1) is a step of heating ink. By the heating, droplets of the ink can be ejected in a heated state from the inkjet head. Thus, the ejection stability can be enhanced.

The temperature of the ink at the time of ejection is preferably 40° C. or more, and the upper limit is preferably 100° C. or less. In order to further enhance the ejection stability, the temperature of the ink at the time of ejection is more preferably in the range of 40 to 90° C. In particular, it is preferable to perform ejection at an ink temperature at which the viscosity of the ink is within a range of 7 to 15 mPa·s, and more preferably within a range of 8 to 13 mPa·s.

As the ink heating method, the ink is preferably heated such that the temperature of the ink at the time of ejection is 40° C. or higher in the channel for supplying the ink to the inkjet head.

As the heating method, for example, it is preferable that at least one of an ink supply system such as an ink tank of a head carriage, a supply pipe, and a front chamber ink tank immediately before the head, a tube with a filter, an inkjet head and the like is heated by an ink heating section.

In particular, in the present invention, the heating step is preferably performed a plurality of times before ejection. Specifically, in the ink supply system, the ink is preferably heated in a first sub tank storing the ink. Furthermore, in addition to the heating in the first sub tank, heating in a second sub tank after deaeration described later and immediately before ejection or heating in an inkjet head is preferable from the viewpoint of improving the ejection properties.

As the ink heating section, a panel heater, a rubber heater, a ribbon heater, warmed water, or the like can be used.

### <Step (2)>

Step (2) is a step of performing deaeration in order to remove air bubbles in the ink.

As the deaeration method, for example, hollow fiber or ultrasonic waves are preferably used.

When the hollow fiber is used, the module is preferably an external reflux type hollow fiber membrane deaeration module in which the inside of the hollow fiber membrane is deaerated and the ink flows to the outside of the hollow fiber membrane. As such an external reflux type hollow fiber membrane deaeration module, for example, one described in WO 2022/102058 can be used. The external reflux type hollow fiber membrane deaeration module is preferable from the viewpoint of deaeration efficiency and a processing flow rate, but the deaeration module is not limited thereto, and other types such as an internal reflux type may be used.

### <Step (3)>

Step (3) is a step of ejecting droplets of the ink from an inkjet head to land them on a recording medium, for example, a printed wiring board, at positions corresponding to a resist film to be formed, to perform patterning.

The ejection method from the inkjet head may be either an on-demand method or a continuous method.

The inkjet head of the on-demand method may be any of an electro-mechanical conversion method such as a single cavity type, a double cavity type, a bender type, a piston type, a share mode type and a shared wall type, and an electro-thermal conversion method such as a thermal inkjet type and a Bubble Jet® type (Bubble Jet is a registered trademark of Canon Inc).

The droplet amount to be ejected is preferably within a range of 2 to 20 pL in terms of recording speed and image quality.

The printed wiring board is not particularly limited, but is preferably, for example, a copper-clad laminate of any grade (FR-4 or the like) using a material such as a copper-clad laminate for a high-frequency circuit using paper phenol, paper epoxy, glass fabric epoxy, glass polyimide, glass fabric/nonwoven fabric epoxy, glass fabric/paper epoxy, synthetic fiber epoxy, fluorine·polyethylene·PPO·cyanate ester, or the like, or another polyimide film, PET film, glass substrate, ceramic substrate, wafer plate, stainless steel plate, or the like.

The printed wiring board is preferably subjected to fine roughening treatment for increasing the contact area with ink in order to improve the adhesiveness with ink.

When an ink is applied by an inkjet method, it is necessary to lower the viscosity of the ink in order to eject the ink with an inkjet head. Therefore, the ink before coating is composed of a polymerizable monomer as a main component, and an ink which is cured by active light after coating is used. In such an ink, curing shrinkage occurs at the time of curing after coating, and the adhesion between the printed wiring board and the ink tends to deteriorate. Therefore, in order to increase the area of contact with the wiring board, it is necessary to perform fine roughening treatment on the wiring board. In addition, since the viscosity of the ink is low, there is a problem that bleeding occurs on the roughened wiring board. Therefore, it is preferable to perform a process for adjusting the contact angle after the roughening treatment of the wiring board.

Therefore, when the ink of the present invention is applied to the above-described use, it is preferable to perform the roughening treatment or treatment for preventing bleeding as pretreatment of the wiring board.

As a method of the roughening treatment, treatment (physical polishing treatment) of forming irregularities on the surface of the wiring board by means of buff, scrub, or the like to form a rough surface is exemplified. As another method of the roughening treatment, chemical polishing treatment such as copper chloride-based, persulfate-based, sulfuric acid/hydrogen peroxide, formic acid-based, or organic acid-based polishing treatment may be mentioned.

As the method of the roughening treatment, from the viewpoint of adhesiveness, chemical polishing treatment is preferable, and organic acid-based treatment is more preferable.

Specific examples of the chemical polishing treatment include: MultiPrep 200 available from MacDermid, Inc. as a copper chloride type; Microclean ME-301 and PR-820 available from MacDermid, Inc. as a persulfate type; GB1000F/1400, G200, GB3100 and GB4300 available from Shikoku Chemicals Co., Ltd., Metex G-5, Metex G-6, ME-501, ME-602, ME-605 and ME-709 available from MacDermid, Inc., BTH-2066 available from BOARDTEC Co., Ltd., and CPE-900, EMR-5000 and EMR-7000 available from Mitsubishi Gas Chemical Co., Ltd., as sulfuric acid/hydrogen peroxide; and CZ8100, CZ8101 and CZ8202 available from Mec Co., Ltd., and BTH-2083 and BTH-2085 available from BOARDTEC as an organic acid type.

In light of adhesiveness, a sulfuric acid/hydrogen peroxide type and an organic acid type are preferable, and an organic acid type is more preferable.

As the treatment for preventing bleeding, CL8300 series manufactured by MEC Co., Ltd, and BTH-3066 manufactured by BOARDTEC Co., Ltd. are preferable.

The surface roughness Ra of the copper plate roughened by the above pretreatment is preferably 0.1 to 1.5 μm, more preferably 0.3 to 1.3 μm, and most preferably 0.4 to 1.1 μm. If the Ra is 0.1 μm or more, the adhesiveness is improved, and if the Ra is 1.5 μm or less, the bleeding is suppressed.

The thickness of the copper plate to be roughened with the pretreatment agent is preferably 0.1 to 3.0 μm, preferably 0.3 to 2.0 μm, more preferably 0.5 to 1.5 μm. If the thickness to be roughened is 0.1 μm or more, the adhesiveness is improved due to the anchor effect, and if it is 3.0 μm or less, the adhesiveness is improved because Cu is not roughened more than necessary.

The surface roughness can be controlled by adjusting conditions such as the type of the pretreatment agent and the temperature and time of the treatment.

The surface roughness can be measured by a laser microscope, a white light interference microscope or the like.

### <Step (4)>

Step (4) is a step of irradiating the ink landed in Step (3) with active rays to temporarily cure the ink.

The active rays can be selected from, for example, electron beam, ultraviolet rays, α rays, γ rays, and X-rays, but are preferably ultraviolet rays.

The irradiation with ultraviolet rays can be performed under conditions of wavelengths of 300 to 420 nm using, for example, water-cooled LEDs manufactured by Phoseon Technology, Inc.

The irradiation with ultraviolet rays is preferably performed such that the peak irradiance of ultraviolet rays having a wavelength in the range of 300 to 420 nm on the resist film surface falls within the range of 0.5 to 10 W/cm². The irradiation with ultraviolet rays is more preferably performed such that the peak irradiance of the ultraviolet rays on the resist film surface falls within the range of 1 to 5 W/cm².

From the viewpoint of suppressing the application of radiation heat to the ink, the amount of light applied to the resist film is preferably less than 1000 mJ/cm².

The irradiation with active rays is preferably performed within 0.001 to 300 seconds after the ink landing, and is more preferably performed within 0.001 to 60 seconds after the ink landing in order to form a highly precise resist film.

### <Step (5)>

Step (5) is a step of, after the temporary curing in Step (4), further heating the ink to perform main curing.

The heating method is, for example, preferably placing the ink in an oven or the like set to a temperature within a range of 110 to 180° C., for 10 to 60 minutes.

### 7. Coating Film Forming Apparatus

The ink of the present invention is suitably used for a coating film forming apparatus. Examples of the coating film forming apparatus include an inkjet recording apparatus provided with an inkjet head.

The inkjet recording apparatus preferably includes an ink heating section, a deaerator, and an inkjet head. The inkjet recording apparatus preferably includes an active ray irradiator (UV irradiator) to irradiate the ink landed on a recording medium with active rays.

As described above, the ink heating section preferably heats the ink such that the temperature of the ink at the time of ejection becomes 40° C. or higher in the channel for supplying the ink to the inkjet head.

It is preferable that the ink heating section is provided in, for example, at least one of an ink supply system such as an ink tank of a head carriage, a supply pipe, and a front chamber ink tank immediately before the head, a tube with a filter, an inkjet head and the like.

In particular, in the present invention, the ink heating section is preferably provided in the first sub tank storing the ink, the second sub tank after deaeration and immediately before ejection, or the inkjet head, in the ink supply system.

As the ink heating section, a panel heater, a rubber heater, a ribbon heater, warmed water, or the like can be used.

The deaerator preferably has, for example, a configuration using hollow fiber.

When the hollow fiber is used, the module is preferably an external reflux type hollow fiber membrane deaeration module in which the inside of the hollow fiber membrane is deaerated and the ink flows to the outside of the hollow fiber membrane.

Note that the deaerator may include an ink heating section.

The active ray irradiator irradiates the ink with energy rays for curing the ink after the ink is ejected onto a recording medium. The active ray irradiator includes, for example, a fluorescent tube, such as a low-pressure mercury lamp, and causes the fluorescent tube to emit light to irradiate the ink with energy rays such as ultraviolet rays.

Examples of the fluorescent tube that emits ultraviolet rays include, in addition to low-pressure mercury lamps, mercury lamps having an operating pressure of about several hundred Pa to 1 MPa. Examples of the fluorescent tube include a light source usable as a germicidal lamp, a cold-cathode tube, an ultraviolet laser light source, a metal halide lamp, and a light-emitting diode. Among these, a light source (for example, a light-emitting diode or the like) which can emit ultraviolet rays with higher illuminance and has low power consumption is more desirable. The energy rays are not limited to ultraviolet rays as long as they are energy rays having a property of curing ink according to the property of the ink, and also the light source is replaced according to the wavelength of the energy rays.

The recording system of the inkjet recording apparatus is preferably a scanning system from the viewpoints of ejection stability and printing accuracy.

Examples of the type of the inkjet recording apparatus include a single-pass printer and a serial printer. The single-pass printer includes a line head having a length (recording medium width) corresponding to the width of a recording medium. In the single-pass printer, the head is fixed without (substantially) moving, and printing is performed in one pass (single pass).

On the other hand, in the serial printer, printing is usually performed in two or more passes (multi-pass) while the head reciprocates (performs shuttle movement) in a direction orthogonal to the conveyance direction of the recording medium.

In the single-pass printer, since it is necessary to form a line head by arranging a plurality of inkjet heads, a relatively large number of inkjet heads are required. On the other hand, the serial printer can be constituted by a small number of recording heads.

### Examples

Hereinafter, the present invention will be specifically described by way of Examples, but the present invention is not limited thereto. Note that in the following Examples, operations were performed at room temperature (25° C.) unless otherwise specified. Further, unless otherwise specified, “%” and “part(s)” mean “% by mass” and “part(s) by mass”, respectively.

### <Preparation of Yellow Pigment Dispersion (Y Dispersion)>

The following dispersant 1 and dispersant 2 and a dispersion medium were placed in a stainless steel beaker, and heated, stirred and dissolved for 1 hour while being heated on a hot plate at 65° C., and cooled to room temperature. Thereafter, the following pigment was added thereto, and the mixture was placed in a glass bottle together with 200 g of zirconia beads having a diameter of 0.5 mm and the glass bottle was hermetically sealed. This was subjected to a dispersion treatment with a paint shaker until a desired particle diameter was obtained, and then the zirconia beads were removed.

| | |
|---|---|
| Dispersant 1: EFKA7701 | 5.6 parts by mass |
| (manufactured by Basf SE) | |
| Dispersant 2: Solsperse22000 | 0.4 parts by mass |
| (manufactured by The Lubrizol Corporation) | |
| Dispersion Medium: dipropylene glycol | 80.6 parts by mass |
| diacrylate (containing 0.2% UV-10) | |
| Pigment: PY147 (pigment yellow 147) | 13.4 parts by mass |
| (Oracet ® Yellow 140 manufactured by Basf SE) | |

### <Preparation of Cyan Pigment Dispersion (C Dispersion)>

Preparation was made in the same manner as the preparation of the yellow pigment dispersion except that the dispersant(s), the dispersion medium and the pigment were changed as shown below.

| | |
|---|---|
| Dispersant: EFKA7701 (manufactured by Basf SE) | 7 parts by mass |
| Dispersion Medium: dipropylene glycol diacrylate | 70 parts by mass |
| (containing 0.2% UV-10) | |
| Pigment: PB15:4 (pigment blue 15:4) (manufactured | 23 parts by mass |
| by Dainichiseika Color & Chemicals | |
| Mfg. Co., Ltd., Chromofine blue 6332JC) | |

### <Blocked Isocyanate>

As the blocked isocyanate, those shown in Table I below were used.

Note that in the following Table III and subsequent Tables, “Trixene BI7982”, “Trixene BI7992”, and “Trixene BI7961” are denoted by “BI7982”, “BI7992”, and “BI7961”, respectively. In addition, “KARENZ MOI-BP” and “KARENZ MOI-BM” are denoted by “MOI-BP” and “MOI-BM”, respectively.

TABLE I

| | PRODUCT | | |
|---|---|---|---|
| | NAME | NAME | COMPANY NAME |
| POLYFUNCTIONAL | TRIXENE | HEXAMETHYLENE DIISOCYANATE TRIMER, | LANXESS |
| BLOCKED | BI7982 | BLOCKING AGENT: DIMETHYLPYRAZOLE | |
| ISOCYANATE | TRIXENE | HEXAMETHYLENE DIISOCYANATE TRIMER, | LANXESS |
| | BI7992 | BLOCKING AGENT: DIMETHYLPYRAZOLE AND | |
| | | DIETHYL MALONATE | |
| | PU5211 | HEXAMETHYLENE DIISOCYANATE TRIMER, | LEESON |
| | | BLOCKING AGENT: 2-BUTANONE OXIME | POLYURETHANES |
| | PU5210 | ISOPHORONE DIISOCYANATE TRIMER, | LEESON |
| | | BLOCKING AGENT: DIMETHYLPYRAZOLE | POLYURETHANES |
| | TRIXENE | HEXAMETHYLENE DIISOCYANATE BIURET, | LANXESS |
| | BI7961 | BLOCKING AGENT: DIMETHYLPYRAZOLE | |
| | KARENZ | 2-[(3,5-DIMETHYLPYRAZOLYL) | SHOWA DENKO |
| | MOI - BP | CARBONYLAMINO] ETHYL METHACRYLATE, | |
| | | BLOCKING AGENT: BLOCKING AGENT: | |
| | | 2-BUTANONE OXIME | |
| | KARENZ | 2-(0-[1′-METHYLPROPYLIDENEAMINO] | SHOWA DENKO |
| | MOI - BM | CARBOXYAMINO) ETHYL METHACRYLATE, | |
| | | BLOCKING AGENT: METHYL ETHYL KETONE OXIME | |

### <Polymerizable Monomer>

As the polymerizable monomer, those shown in Table II below were used.

TABLE II

| | | PRODUCT | | |
|---|---|---|---|---|
| | | NAME | COMPANY NAME | NAME, ETC. |
| POLYMERIZABLE | BISPHENOL | EA-1010N | SHIN-NAKAMURA | GLYCIDYL ETHER-CONTAINING EPOXY ACRYLATE |
| MONOMER | A-TYPE | | CHEMICAL | BISPHENOL A SKELTON |
| | EPOXY | XY-4000 | MITSUBISHI | BISPHENOL A-TYPE EPOXY RESIN |
| | ACRYLATE | | CHEMICAL | |
| | EO-MODIFIED | EBECRYL | DAICEL-ALLNEX | EO-MODIFIED BISPHENOL A DIACRYLATE |
| | BISPHENOL | 150 | | |
| | A-TYPE | A-BPE-4A | SHIN-NAKAMURA | EO-MODIFIED BISPHENOL A DIACRYLATE |
| | DIACRYLATE | | CHEMICAL | |
| | | A-BPE-10A | SHIN-NAKAMURA | EO-MODIFIED BISPHENOL A DIACRYLATE |
| | | | CHEMICAL | |
| | OTHER | TMP-3 | DKS | EO-MODIFIED TRIMETHYLOLPROPANE |
| | (METH) | | | TRIACRYLATE |
| | ACRYLATE | SR499 | ARKEMA | 6EO-MODIFIED TRIMETHYLOLPROPANE |
| | | | | TRIACRYLATE |
| | | HDDA | OSAKA ORGANIC | 1,6-HEXANEDIOL DIACRYLATE |
| | | | CHEMICAL | |
| | | | INDUSTRY | |
| | | DPGDA | DAICEL-ALLNEX | DIPROPYLENE GLYCOL DIACRYLATE |
| | | 4HBA | OSAKA ORGANIC | 4-HYDROXYBUTYL ACRYLATE |
| | | | CHEMICAL | |
| | | | INDUSTRY | |
| | | CHDMMA | NIHON KASEI | 1,4-CYCLOHEXANEDIMETHANOL MONOACRYLATE |
| | | DA-911M | NAGASE | ALIPHATIC POLYHYDRIC ALCOHO-BASED EPOXY |
| | | | CHEMTEX | ACRYLATE |
| | | SR834 | ARKEMA | TRICYCLODECANE DIMETHANOL |
| | | | | DIMETHACRYLATE |
| | | NIK ESTER | SHIN-NAKAMURA | 1,10-DECANEDIOL DIMETHACRYLATE |
| | | DOD-N | CHEMICAL | |
| | | MONOMER | — | *1 |
| | | F | | |
| | | MONOMER | — | *2 |
| | | G | | |
| | | NK ESTER | SHIN-NAKAMURA | TRIETHYLENE GLYCOL DIMETHACRYLATE |
| | | 3G | CHEMICAL | |
| | | NK ESTER | SHIN-NAKAMURA | POLYETHYLENE GLYCOL DIACRYLATE |
| | | A-400 | CHEMICAL | |

*1 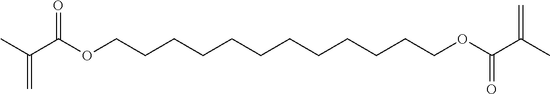 [SMILES: C=C(C)C(=O)OCCCCCCCCCCCCOC(=O)C(=C)C]
1,12-DODECANEDIOL DIMETHACRYLATE
*2

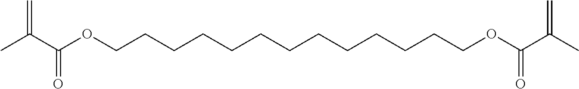 [SMILES: C=C(C)C(=O)OCCCCCCCCCCCCCOC(=O)C(=C)C]

### <Photopolymerization Initiator>

As the photopolymerization initiator, those show below were used
Omnirad 379EG (manufactured by Igm Resins B.V.)
Omnirad TPO H (manufactured by Igm Resins B.V.)
Speedcure 2-ITX (manufactured by Sartomer Company, 2-isopropylthioxanthone)

### <Other Additives>

Melamine
   <Preparation of inkjet Ink>

The components were mixed according to the ink compositions shown Table III to Table VII below. The mixed liquids were cleared by a Teflon® 3-μm membrane filter produced by ADVANTEC while being heated to 60° C., thereby obtaining inks 1 to 25.

TABLE III
[parts by mass]

| INK NO. | | | ClogP | INK 1 | INK 2 | INK 3 | INK 4 |
|---|---|---|---|---|---|---|---|
| POLYFUNCTIONAL BLOCKED | | BI7982 | | 10.0 | 15.0 | 20.0 | 25.0 |
| ISOCYANATE | | BI7992 | — | — | — | — | — |
| | | PU5211 | — | — | — | — | — |
| | | PU5210 | — | — | — | — | — |
| | | BI7961 | — | — | — | — | — |
| | | MOI - BP | — | — | — | — | — |
| | | MOI - BM | — | — | — | — | — |
| POLYMERIZABLE | BISPHENOL | EA-1010N | 4.1 | 5.0 | 5.0 | 5.0 | 5.0 |
| MONOMER | A-TYPE EPOXY | XY-4000 | 4.9 | — | — | — | — |
| | ACRYLATE | | | | | | |
| | EO-MODIFIED | EBECRYL 150 | 4.0 | 15.0 | 15.0 | 15.0 | 15.0 |
| | BISPHENOL | A-BPE-4A | 4.9 | — | — | — | — |
| | A-TYPE | A-BPE-10A | 4.9 | — | — | — | — |
| | DIACRYLATE | | | | | | |
| | OTHER (METH) | TMP-3 | 4.0 | 10.0 | 10.0 | 5.0 | 5.0 |
| | ACRYLATE | SR499 | 3.6 | — | — | — | — |
| | | HDDA | 3.1 | 15.0 | 15.0 | 15.0 | 15.0 |
| | | DPGDA | 2.0 | 27.8 | 22.8 | 22.8 | 17.8 |
| | | 4HBA | 0.4 | 3.0 | 3.0 | 3.0 | 3.0 |
| | | CHDMMA | 2.1 | — | — | — | — |
| | | DA-911M | −0.4 | — | — | — | — |
| | | SR834 | 5.1 | — | — | — | — |
| | | NK ESTER DOD-N | 5.8 | — | — | — | — |
| | | MONOMER F | 6.8 | — | — | — | — |
| | | MONOMER G | 7.3 | — | — | — | — |
| | | NK ESTER 3G | 1.9 | — | — | — | — |
| | | NK ESTER A-400 | 0.5 | — | — | — | — |

| | | | | | | |
|---|---|---|---|---|---|---|
| PHOTOPOLYMERIZATION | OMNIRAD 379EG | — | 4.0 | 4.0 | 4.0 | 4.0 |
| INITIATOR | OMNIRAD TPO H | — | 3.0 | 3.0 | 3.0 | 3.0 |
| | 2-ITX | — | 0.2 | 0.2 | 0.2 | 0.2 |
| OTHER ADDITIVE | MELAMINE | — | 1.0 | 1.0 | 1.0 | 1.0 |
| C DISPERSION | PIGMENT BLUE 15:4 | — | 3.0 | 3.0 | 3.0 | 3.0 |
| Y DISPERSION | PIGMENT YELLOW 147 | — | 3.0 | 3.0 | 3.0 | 3.0 |

TABLE IV
[parts by mass]

| INK NO. | | | INK 5 | INK 6 | INK 7 | INK 8 | INK 9 | INK 10 |
|---|---|---|---|---|---|---|---|---|
| POLYFUNCTIONAL BLOCKED | | BI7982 | | | | | | |
| ISOCYANATE | | BI7992 | 15.0 | — | — | — | — | — |
| | | PU5211 | — | 15.0 | — | — | — | — |
| | | PU5210 | — | — | 15.0 | — | — | — |
| | | BI7961 | — | — | — | 15.0 | — | — |
| | | MOI - BP | — | — | — | — | 15.0 | — |
| | | MOI - BM | — | — | — | — | — | 15.0 |
| POLYMERIZABLE | BISPHENOL | EA-1010N | 5.0 | 5.0 | 5.0 | 5.0 | 5.0 | 5.0 |
| MONOMER | A-TYPE EPOXY | XY-4000 | — | — | — | — | — | — |
| | ACRYLATE | | | | | | | |
| | EO-MODIFIED | EBECRYL | 15.0 | 15.0 | 15.0 | 15.0 | 15.0 | 15.0 |
| | BISPHENOL | 150 | | | | | | |
| | A-TYPE | A-BPE-4A | — | — | — | — | — | — |
| | DIACRYLATE | A-BPE-10A | — | — | — | — | — | — |
| | OTHER (METH) | TMP-3 | 10.0 | 10.0 | 10.0 | 10.0 | 10.0 | 10.0 |
| | ACRYLATE | SR499 | — | — | — | — | — | — |
| | | HDDA | 15.0 | 15.0 | 15.0 | 15.0 | 15.0 | 15.0 |
| | | DPGDA | 22.8 | 22.8 | 22.8 | 22.8 | 22.8 | 22.8 |
| | | 4HBA | 3.0 | 3.0 | 3.0 | 3.0 | 3.0 | 3.0 |
| | | CHDMMA | — | — | — | — | — | — |
| | | DA-911M | — | — | — | — | — | — |
| | | SR834 | — | — | — | — | — | — |
| | | NK ESTER DOD-N | — | — | — | — | — | — |
| | | MONOMER F | — | — | — | — | — | — |
| | | MONOMER G | — | — | — | — | — | — |
| | | NK ESTER 3G | — | — | — | — | — | — |
| | | NK ESTER A-400 | — | — | — | — | — | — |

| | | | | | | | |
|---|---|---|---|---|---|---|---|
| PHOTOPOLYMERIZATION | OMNIRAD 379EG | 4.0 | 4.0 | 4.0 | 4.0 | 4.0 | 4.0 |
| INITIATOR | OMNIRAD TPO H | 3.0 | 3.0 | 3.0 | 3.0 | 3.0 | 3.0 |
| | 2-ITX | 0.2 | 0.2 | 0.2 | 0.2 | 0.2 | 0.2 |
| OTHER ADDITIVE | MELAMINE | 1.0 | 1.0 | 1.0 | 1.0 | 1.0 | 1.0 |
| C DISPERSION | PIGMENT BLUE 15:4 | 3.0 | 3.0 | 3.0 | 3.0 | 3.0 | 3.0 |
| Y DISPERSION | PIGMENT YELLOW 147 | 3.0 | 3.0 | 3.0 | 3.0 | 3.0 | 3.0 |

TABLE V
[parts by mass]

| INK NO. | | | INK 11 | INK 12 | INK 13 | INK 14 | INK 15 | INK 16 |
|---|---|---|---|---|---|---|---|---|
| POLYFUNCTIONAL BLOCKED | | BI7982 | 15.0 | 15.0 | 15.0 | 15.0 | 20.0 | 25.0 |
| ISOCYANATE | | BI7992 | — | — | — | — | — | — |
| | | PU5211 | — | — | — | — | — | — |
| | | PU5210 | — | — | — | — | — | — |
| | | BI7961 | — | — | — | — | — | — |
| | | MOI - BP | — | — | — | — | — | — |
| | | MOI - BM | — | — | — | — | — | — |
| POLYMERIZABLE | BISPHENOL | EA-1010N | — | — | — | 5.0 | 5.0 | 5.0 |
| MONOMER | A-TYPE EPOXY | XY-4000 | 5.0 | 5.0 | 5.0 | — | — | — |
| | ACRYLATE | | | | | | | |
| | EO-MODIFIED | EBECRYL 150 | 15.0 | — | — | 15.0 | 15.0 | 15.0 |
| | BISPHENOL | A-BPE-4A | — | 15.0 | — | — | — | — |
| | A-TYPE | A-BPE-10A | — | — | 15.0 | — | — | — |
| | DIACRYLATE | | | | | | | |
| | OTHER (METH) | TMP-3 | 10.0 | 10.0 | 10.0 | 5.0 | 5.0 | 5.0 |
| | ACRYLATE | SR499 | — | — | — | — | — | — |
| | | HDDA | 15.0 | 15.0 | 15.0 | 15.0 | 15.0 | 15.0 |
| | | DPGDA | 22.8 | 22.8 | 22.8 | 10.8 | 5.8 | 0.8 |
| | | 4HBA | 3.0 | 3.0 | 3.0 | — | — | — |
| | | CHDMMA | — | — | — | — | — | — |
| | | DA-911M | — | — | — | — | — | — |
| | | SR834 | — | — | — | 20.0 | 20.0 | — |
| | | NK ESTER DOD-N | — | — | — | — | — | — |
| | | MONOMER F | — | — | — | — | — | 20.0 |
| | | MONOMER G | — | — | — | — | — | — |
| | | NK ESTER 3G | — | — | — | — | — | — |
| | | NK ESTER A-400 | — | — | — | — | — | — |

| | | | | | | | |
|---|---|---|---|---|---|---|---|
| PHOTOPOLYMERIZATION | OMNIRAD 379EG | 4.0 | 4.0 | 4.0 | 4.0 | 4.0 | 4.0 |
| INITIATOR | OMNIRAD TPO H | 3.0 | 3.0 | 3.0 | 3.0 | 3.0 | 3.0 |
| | 2-ITX | 0.2 | 0.2 | 0.2 | 0.2 | 0.2 | 0.2 |
| OTHER ADDITIVE | MELAMINE | 1.0 | 1.0 | 1.0 | 1.0 | 1.0 | 1.0 |
| C DISPERSION | PIGMENT BLUE 15:4 | 3.0 | 3.0 | 3.0 | 3.0 | 3.0 | 3.0 |
| Y DISPERSION | PIGMENT YELLOW 147 | 3.0 | 3.0 | 3.0 | 3.0 | 3.0 | 3.0 |

TABLE VI
[parts by mass]

| INK NO. | | | INK 17 | INK 18 | INK 19 | INK 20 | INK 21 |
|---|---|---|---|---|---|---|---|
| POLYFUNCTIONAL BLOCKED | | BI7982 | 25.0 | 15.0 | 15.0 | 15.0 | 15.0 |
| ISOCYANATE | | BI7992 | — | — | — | — | — |
| | | PU5211 | — | — | — | — | — |
| | | PU5210 | — | — | — | — | — |
| | | BI7961 | — | — | — | — | — |
| | | MOI - BP | — | — | — | — | — |
| | | MOI - BM | — | — | — | — | — |
| POLYMERIZABLE | BISPHENOL | EA-1010N | 5.0 | 5.0 | 5.0 | 5.0 | 5.0 |
| MONOMER | A-TYPE EPOXY | XY-4000 | — | — | — | — | — |
| | ACRYLATE | | | | | | |
| | EO-MODIFIED | EBECRYL 150 | 15.0 | 15.0 | 15.0 | 15.0 | 5.0 |
| | BISPHENOL | A-BPE-4A | — | — | — | — | — |
| | A-TYPE | A-BPE-10A | — | — | — | — | — |
| | DIACRYLATE | | | | | | |
| | OTHER (METH) | TMP-3 | 5.0 | 10.0 | 10.0 | 10.0 | 10.0 |
| | ACRYLATE | SR499 | — | — | — | — | — |
| | | HDDA | 15.0 | 15.0 | 15.0 | 15.0 | 15.0 |
| | | DPGDA | 0.8 | 15.8 | 10.8 | 10.8 | 25.8 |
| | | 4HBA | — | 10.0 | 15.0 | — | — |
| | | CHDMMA | — | — | — | 15.0 | — |
| | | DA-911M | — | — | — | — | 10.0 |
| | | SR834 | — | — | — | — | — |
| | | NK ESTER DOD-N | — | — | — | — | — |
| | | MONOMER F | — | — | — | — | — |
| | | MONOMER G | 20.0 | — | — | — | — |
| | | NK ESTER 3G | — | — | — | — | — |
| | | NK ESTER A-400 | — | — | — | — | — |

| | | | | | | |
|---|---|---|---|---|---|---|
| PHOTOPOLYMERIZATION | OMNIRAD 379EG | 4.0 | 4.0 | 4.0 | 4.0 | 4.0 |
| INITIATOR | OMNIRAD TPO H | 3.0 | 3.0 | 3.0 | 3.0 | 3.0 |
| | 2-ITX | 0.2 | 0.2 | 0.2 | 0.2 | 0.2 |
| OTHER ADDITIVE | MELAMINE | 1.0 | 1.0 | 1.0 | 1.0 | 1.0 |
| C DISPERSION | PIGMENT BLUE 15:4 | 3.0 | 3.0 | 3.0 | 3.0 | 3.0 |
| Y DISPERSION | PIGMENT YELLOW 147 | 3.0 | 3.0 | 3.0 | 3.0 | 3.0 |

TABLE VII
[parts by mass]

| INK NO. | | | INK 22 | INK 23 | INK 24 | INK 25 |
|---|---|---|---|---|---|---|
| POLYFUNCTIONAL BLOCKED | | B17982 | 15.0 | 15.0 | 15.0 | 15.0 |
| ISOCYANATE | | B17992 | — | — | — | — |
| | | PU5211 | — | — | — | — |
| | | PU5210 | — | — | — | — |
| | | BI7961 | — | — | — | — |
| | | MOI - BP | — | — | — | — |
| | | MOI - BM | — | — | — | — |
| POLYMERIZABLE | BISPHENOL | EA-1010N | 5.0 | 5.0 | 5.0 | 5.0 |
| MONOMER | A-TYPE EPOXY | XY-4000 | — | — | — | — |
| | ACRYLATE | | | | | |
| | EO-MODIFIED | EBECRYL 150 | — | — | 15.0 | — |
| | BISPHENOL | A-BPE-4A | — | — | — | — |
| | A-TYPE | A-BPE-10A | — | — | — | — |
| | DIACRYLATE | | | | | |
| | OTHER (METH) | TMP-3 | 10.0 | 10.0 | 10.0 | 10.0 |
| | ACRYLATE | SR499 | — | — | — | — |
| | | HDDA | 0.0 | 0.0 | 15.0 | 15.0 |
| | | DPGDA | 10.0 | 10.0 | 5.8 | 21.2 |
| | | 4HBA | 3.0 | 3.0 | 20.0 | 10.0 |
| | | CHDMMA | — | — | — | — |
| | | DA-911M | — | — | — | 15.0 |
| | | SR834 | — | — | — | — |
| | | NK ESTER DOD-N | — | — | — | — |
| | | MONOMER F | — | — | — | — |
| | | MONOMER G | — | — | — | — |
| | | NK ESTER 3G | 42.8 | — | — | — |
| | | NK ESTER A-400 | — | 42.8 | — | — |

| | | | | | |
|---|---|---|---|---|---|
| PHOTOPOLYMERIZATION | OMNIRAD 379EG | 4.0 | 4.0 | 4.0 | 4.0 |
| INITIATOR | OMNIRAD TPO H | 3.0 | 3.0 | 3.0 | 3.0 |
| | 2-ITX | 0.2 | 0.2 | 0.2 | 0.2 |
| OTHER ADDITIVE | MELAMINE | 1.0 | 1.0 | 1.0 | 1.0 |
| C DISPERSION | PIGMENT BLUE 15:4 | 3.0 | 3.0 | 3.0 | 0.2 |
| Y DISPERSION | PIGMENT YELLOW 147 | 3.0 | 3.0 | 3.0 | 0.4 |

### <Moisture Content of Ink>

A Karl Fischer moisture meter (MKV-710, manufactured by Kyoto Electronics Manufacturing Co., Ltd) was used for measurement of the moisture content of each ink when the ink was stored in an environment of a temperature in the range of −15 to 40° C., and a humidity of 60% RH or less for one year from the production. Details of the method for calculating the moisture content are as described above.

### <Hydroxy Value in Ink>

The hydroxy value in each ink was calculated from the feed composition of the compound(s) having a hydroxy group in 1 g of the ink. A specific calculation method is as in the following formula (a).

$$Hydroxy value [ mgKOH / g ] = A [ mol ] \times \qquad ( a )$$

$$[ Number of Hydroxy Groups of Compounds having Hydroxy Group ] \times B [ mg / mol ]$$

In the above formula (a), “A” represents the number of moles of the compound having a hydroxy group in 1 g of ink. Further, “B” represents the molecular weight of 1 mol of potassium hydrate (56000 [mg/mol]).

If two or more types of compound having a hydroxy group are contained in the ink, the hydroxy value is calculated for each compound having a hydroxy group by the formula (a). Then, the sum of the obtained hydroxyl values is defined as the hydroxyl value in 1 g of the ink.

### <Treatment of Copper Substrate>

A copper-clad laminate(s) for a printed wiring board(s) (FR-4, thickness of 1.6 mm, size of 150 mm×95 mm) was treated with a treatment solution of CZ-8100 manufactured by MEC. Thus, pretreated copper substrates having a surface roughness Ra of 1.5 μm and a treatment depth of 1 μm were produced.

### <Pattern Formation by Inkjet>

Each ink after being stored for one year from the production in the environment of a temperature in the range of −15 to 40° C., and a humidity of 60% RH or less was loaded into an inkjet recording apparatus having an inkjet recording head equipped with a piezo-type inkjet nozzle. Using this apparatus, a pattern was formed on the pretreated copper-clad laminate for a printed wiring board (FR-4, thickness of 1.6 mm, size of 150 mm×95 mm).

The ink supply system of the apparatus consists of an ink tank, an ink channel, a sub ink tank provided immediately before the inkjet recording head, a tube with a metal filter, and a piezo head.

The ink from the ink tank to the head portion was heated to 60° C. Next, the ink temperature in the piezo head was heated to 55° C. by a heater built in the piezo head. As the piezo head, KM1800i-SHC manufactured by Konica Minolta, Inc. was used.

Using this inkjet recording apparatus, a voltage was applied such that the droplet amount became a dot of 3.5 pl. Then, a 70 mm×70 mm solid pattern and a comb-shaped pattern with lines & space of 100 μm were printed on the substrate such that they each had a thickness of 30 μm. Thereafter, an LED lamp (365 nm) manufactured by Phoseon Technology, Inc. emits light at 1000 mJ/cm², thereby temporarily curing the ink layer. Thereafter, it was placed in an oven set at 150° C., for 60 minutes for the main curing to be further irradiated at 2000 mJ/cm² by a mercury vapor lamp, so that a printed sample was obtained.

### [Evaluation]

### <Amount of Solid Matter Generated>

Each ink was stored in an environment of a temperature in the range of −15 to 40° C., and a humidity of 60% RH or less for one year from the production. After the storage, the ink was stored at an ejection temperature (60° C.) for one day, and then 300 ml of the ink was subjected to pressure filtration using a 5 μm PTFE filter (diameter of 2 mm). Thereafter, the 5-μm PTFE filter was taken out and washed with ethanol, and then the presence or absence of generation of a solid matter was checked with an optical microscope and evaluation was made according to the following criteria. In the following criteria, “A” and “B” indicate no practical problem.

### (Criteria)

A: No solid matter is present on the entire surface of the filter.

B: Solid matter is present in the range of less than 1% of the filter area.

C: Solid matter is present in the range of 1% or more and less than 10% of the filter area.

D: Solid matter is present in the range of 10% or more of the filter area.

### <Ejection Stability of Ink>

The piezo head was used to continuously eject (drive) the ink under the conditions of a droplet amount of 3.5 pl, a droplet speed of 7 m/sec, an ejection frequency of 40 kHz, and a printing rate of 100%. Then, the number of non-ejecting nozzles was counted after 1 minute, 5 minutes, and 10 minutes from the start of driving, and evaluation was made according to the following criteria. In the following criteria, “A” and “B” indicate no practical problem.

### (Criteria)

A: The number of deficient nozzles is less than two.

B: The number of deficient nozzles is two or more and less than 10.

C: The number of deficient nozzles is 10 or more and less than 50.

D: The number of deficient nozzles is 50 or more.

### <Adhesiveness to Substrate>

For the printed sample of the solid pattern, cuts were made in the cured film in a grid pattern in accordance with JIS K5600's cross-cut method, and adhesive tape was attached and peeled off to observe the state of peeling of the cured film. Here, an adhesion residual percentage was calculated using the number of squares formed by making cuts as a denominator and the number of squares remaining after tape peeling as a numerator. The calculated adhesion residual percentage was evaluated in accordance with the following criteria. In the following criteria, “A” and “B” indicate no practical problem.

### (Criteria)

A: The adhesion residual percentage is 100%.

B: The adhesion residual percentage is 80% or more and less than 100%.

C: The adhesion residual percentage is 60% or more and less than 80%.

D: The adhesion residual percentage is less than 60%.

TABLE VIII

| | CONTENT OF | | MOISTURE | | | | |
|---|---|---|---|---|---|---|---|
| | COMPOUND | | CONTENT | AMOUNT | | | |
| | HAVING ClogP | HYDROXY | AFTER | OF SOLID | | | |
| INK | of 2 to 7 | VALUE | ONE YEAR | MATTER | EJECTION | ADHESIVENESS | |
| NO. | [mass %] | [mgKOH/g] | STORAGE | GENERATED | STABILITY | TO SUBSTRATE | REMARKS |
| 1 | 72.8 | 11.7 | 0.65 | A | A | A | PRESENT INVENTION |
| 2 | 67.8 | 11.7 | 0.65 | A | A | A | PRESENT INVENTION |
| 3 | 62.8 | 11.7 | 0.65 | A | A | A | PRESENT INVENTION |
| 4 | 57.8 | 11.7 | 0.65 | A | A | A | PRESENT INVENTION |
| 5 | 67.8 | 11.7 | 0.65 | A | A | A | PRESENT INVENTION |
| 6 | 67.8 | 11.7 | 0.65 | A | A | A | PRESENT INVENTION |
| 7 | 67.8 | 11.7 | 0.65 | A | A | A | PRESENT INVENTION |
| 8 | 67.8 | 11.7 | 0.65 | A | A | A | PRESENT INVENTION |
| 9 | 67.8 | 11.7 | 0.65 | A | A | A | PRESENT INVENTION |
| 10 | 67.8 | 11.7 | 0.65 | A | A | A | PRESENT INVENTION |
| 11 | 67.8 | 11.7 | 0.65 | A | A | A | PRESENT INVENTION |
| 12 | 67.8 | 11.7 | 0.65 | A | A | A | PRESENT INVENTION |
| 13 | 67.8 | 11.7 | 0.65 | A | A | A | PRESENT INVENTION |
| 14 | 70.8 | 0.0 | 0.60 | A | A | A | PRESENT INVENTION |
| 15 | 65.8 | 0.0 | 0.55 | A | A | A | PRESENT INVENTION |
| 16 | 60.8 | 0.0 | 0.55 | A | A | A | PRESENT INVENTION |
| 17 | 60.8 | 0.0 | 0.50 | A | A | B | PRESENT INVENTION |
| 18 | 60.8 | 38.9 | 0.70 | A | A | A | PRESENT INVENTION |
| 19 | 55.8 | 58.3 | 0.75 | B | B | A | PRESENT INVENTION |
| 20 | 70.8 | 42.4 | 0.70 | A | A | A | PRESENT INVENTION |
| 21 | 60.8 | 37.1 | 0.70 | B | B | A | PRESENT INVENTION |
| 22 | 25.0 | 11.7 | 1.00 | D | D | C | COMPARATIVE |
| | | | | | | | EXAMPLE |
| 23 | 25.0 | 11.7 | 1.00 | D | D | A | COMPARATIVE |
| | | | | | | | EXAMPLE |
| 24 | 50.8 | 77.8 | 0.90 | D | D | A | COMPARATIVE |
| | | | | | | | EXAMPLE |
| 25 | 51.2 | 94.5 | 0.90 | D | D | B | COMPARATIVE |
| | | | | | | | EXAMPLE |

As indicated by the results shown above, it is found that the ink of the present invention suppresses generation of a solid matter even when it was stored for a long period of time, has satisfactory ejection properties, and is excellent in adhesiveness to the substrate, as compared with the ink of the comparative example.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2023-107792 filed on Jun. 30, 2023, including description, claims, drawings and abstract is incorporated herein by reference.

What is claimed is:

1. An inkjet ink comprising a polymerizable monomer, a blocked isocyanate, and a photopolymerization initiator,
wherein when the inkjet ink is stored at a temperature in a range of −15 to 40° C., and a humidity of 60% RH or less for one year from production thereof, a moisture content of the inkjet ink measured by a Karl Fischer method is in a range of 0.05 to 0.80 mass % with respect to a total mass of the inkjet ink.

2. The inkjet ink according to claim 1, wherein the inkjet ink is ejected at 40° C. or higher.

3. The inkjet ink according to claim 1, wherein the blocked isocyanate has an aromatic ring structure.

4. The inkjet ink according to claim 1, wherein the blocked isocyanate has an isocyanurate structure.

5. The inkjet ink according to claim 1, wherein a content of the polymerizable monomer having an octanol-water partition coefficient (C log P) value in a range of 2.0 to 7.0 in the inkjet ink is 30 mass % or more.

6. The inkjet ink according to claim 1, wherein the polymerizable monomer includes at least one type of a polymerizable monomer having a bisphenol A structure.

7. The inkjet ink according to claim 1, wherein a sum of a hydroxy value of a compound having a hydroxy group contained in the inkjet ink is 60 mgKOH/g or less.

8. A method for storing the inkjet ink according to claim 1, comprising:
storing the inkjet ink at a temperature in a range of −15 to 40° C., and a humidity of 60% RH or less.
